(19) United States
(12) Patent Application Publication
(10) Pub. No.: US 2026/0101384 A1
(43) Pub. Date: Apr. 9, 2026

(54) Signaling PRACH Configuration for Initial Random Access in SBFD Networks

(71) Applicant: Charter Communications Operating, LLC, St. Louis, MO (US)

(72) Inventors: Phillip Babatunde Oni, Irving, TX (US); Mojtaba Ahmadi Almasi, Portland, OR (US); Dumitru M. Ionescu, Poway, CA (US)

(21) Appl. No.: 19/349,283

(22) Filed: Oct. 3, 2025

Related U.S. Application Data
(60) Provisional application No. 63/703,854, filed on Oct. 4, 2024.
(60) Provisional application No. 63/706,744, filed on Oct. 13, 2024.

(51) Int. Cl. H04W 74/0833; H04L 5/14; H04W 72/0457

(52) U.S. Cl. CPC H04W 74/0833; H04L 5/14; H04W 72/0457

(57) ABSTRACT

Methods and apparatus for sub-band full duplex (SBFD) Random Access Channel (RACH) configuration are described. In some embodiments, existing legacy Radio Resource Control (RRC) Information Elements (IEs), e.g., msg1-Frequency Start and msg-1 FDM, are re-used to signal RACH configuration to SBFD-aware UEs. In some embodiments, new RRC signaling IEs, e.g., msg1-FrequencyStartSBFD-r19, msg1-FDM-SBFD-19, ra-Msg1-RO-FrequencyOffsetSBFD-r19, and/or ra-RO-ScalingFactorSBFD-r19, are introduced specifically for SBFD RACH configuration for SBFD-aware UEs. The RACH configuration will be conveyed to the SBFD UEs via system information block 1 (SIB1), which is transmitted by a base station, e.g. gNB over the Physical Downlink Shared Channel (PDSCH). The UE reads the RACH configuration upon decoding SIB1 and then uses the information to determine resources to be used in a RACH access attempt.

### RELATED APPLICATIONS

The present application claims the benefit of U.S. Provisional Patent Application titled “Methods and Apparatus for Communicating and Using PRACH Configuration for Initial Random Access in SBFD Networks” which was filed on Oct. 4, 2024 and assigned application Ser. No. 63/703,854 and which is hereby expressly incorporated by reference in its entirety, and also claims the benefit of U.S. Provisional Patent Application titled “Methods and Apparatus for Communicating and Using PRACH Configuration for Initial Random Access in SBFD Networks” which was filed on Oct. 13, 2024 and assigned application Ser. No. 63/706,744 and which is also hereby expressly incorporated by reference in its entirety.

### FIELD

The present application relates to communications methods and apparatus, and more particularly, to methods and apparatus for communicating Physical Random Access Channel (PRACH) configuration in a wireless communications system implementing sub-band full duplex (SBFD).

### BACKGROUND

Sub-band full duplex (SBFD) is a recent form of full duplexing that enables the simultaneous transmission of uplink (UL) and downlink (DL) signals using non-overlapping frequency resources within the confines of the same unpaired time division duplexing (TDD) carrier. Support for SBFD and inclusion of SBFD slots in timing structures used for controlling communication systems is currently under discussion. While the introduction of SBFD slots, in which a portion of the slot is used for downlink communications and another, often smaller, portion of resources in the slot are used for uplink communications, has the potential to reduce the time between opportunities for a user equipment (UE) to attempt to access a network, it introduces complexities and needs for communicating control information to allow a UE to understand which portions of a SBFD are available to the UE for access attempts and/or other uplink communications while other portions of the same slot are being used for downlink signaling.

The introduction of UEs capable of using uplink transmission opportunities in SBFD slots introduces opportunities to reduce the time required to connect to a network, e.g., by reducing the time between random access opportunities, but also creates signaling and resource utilization issues associated with SBFD utilization. The issues are complicated by the fact that many networks will likely include some UEs or other devices which are not capable of utilizing SBFD slots and/or uplink resources in such slots because they predate or do not include support for using SBFD slots and/or uplink resources in such slots. Devices which are able to take advantage of the features and/or transmission opportunities provided by SBFD slots are sometimes referred to as SBFD aware devices. In systems which support SBFD slots, timing structures used in the communication system can include a combination of Uplink only slots, sometimes referred to as Uplink slots, in which UEs can transmit uplink signals to base stations, e.g., gNBs, Downlink only slots, sometimes referred to as Downlink slots, and SBFD slots which can include a mix of Uplink and/or Downlink resources.

UEs or other devices which do not support the use of SBFD signaling or slots, e.g., because they predate or do not support such functionality, are referred to as non-SBFD devices or non-SBFD aware devices. Accordingly, a non-SBFD aware device is a device which cannot take advantage of features made possible by SBFD functionality.

Before a UE can communicate via a network it must perform what is sometimes referred to as an initial access. Initial access is performed before data communication occurs with the UE trying to connect to a network via a base station, e.g., gNB. When performing an initial access, a UE does not know which gNB it is trying to connect to. To establish the connection, UE and gNB follow an initial access procedure.

A common initial access procedure includes two main steps: a cell search step and a random access step. During cell search, a UE receives necessary information about the gNB that it wants to connect to along with synchronization signals and information about random access channel.

After receiving information about the random access channel, a UE will normally proceed with a random access procedure. FIG. 1 is a diagram 100 illustrating the steps of a known 4-step Contention-based Random Access (CBRA) which is representative of the 4-step CBRA, which is a Rel-15 feature, as described in 3GPP TS 38.300. Title box 101 indicates that diagram 100 illustrates 4-step CBRA message sequence of 3GPP TS 38.300. FIG. 1 further includes exemplary UE 10 and exemplary gNB 12, which exchange messages.

After receiving the necessary information, UE 10 is still unknown at gNB 12. So, the following four messages are exchanged. MSG1 communication 14: the UE 10 first sends a physical random access channel (PRACH) signal 102 including a random access preamble in preconfigured RACH occasions (ROs). MSG2 communication 16: if the signal 102 is successfully received at gNB 12, the gNB 12 will send a random access response (RAR) signal 104 including a random access preamble response to the UE 10. The RAR 104 includes time advance, random access preamble index (RAPID), and an initial uplink grant for UE 10. Also, the RAR 104 assigns a temporary identifier called TC-RNTI to the UE 10. MSG3 communication 18: the UE 10 transmits a scheduled transmission message 106 including an RRC setup request on a physical uplink share channel (PUSCH). MSG4 communication 20: the gNB 12 sends MSG4 108, which is a contention resolution message, to the UE 10 which is for contention resolution. This message 108 includes the UE's identity, confirming that gNB 12 has correctly identified the UE 10, and contention has been resolved. At this step, network provides UE 10 with a Cell Radio Network Temporary Identifier (C-RNTI).

Regarding MSG1-PRACH Transmission, it should be understood with regard to the PRACH that the UE can transmit a single or multiple PRACH signals in each RACH attempt. Legacy UEs use non-subband full duplex (non-SBFD) ROs (a.k.a. legacy ROs) for PRACH transmission. A UE may or may not repeat PRACH signal. SBFD-aware UEs can use non-SBFD and/or SBFD ROs for PRACH transmission.

To avoid resource conflicts and other issues relating to SBFD functionality allowing UEs to transmit uplink signals in an SBFD slot which is also used for downlink signaling, methods and/or apparatus need to be developed. While a large number of signaling and/or control issues need to be resolved with regard to supporting SBFD functionality, it should be appreciated that there is a need for methods and/or apparatus for base stations, e.g., gNBs, to signal wireless devices such as UEs regarding SBFD resources and how they can be used. In addition, there is a need for methods and/or apparatus which allow wireless devices, e.g., UEs, to determine what resources are available for use in SBFD slots and how they may be used, e.g., for RACH or other communications purposes. Preferably, new methods and/or apparatus should be capable of being implemented without requiring changes to existing devices, e.g., non-SBFD aware devices, thereby allowing a network to include a mix of non-SBFD aware devices and/or SBFD aware devices.

While there are a large number of needs with regard to improving and/or supporting SBFD in a communications system, any improvements with regard to supporting SBFD would be desirable or beneficial and thus features which support some but not necessarily all the issues with SBFD information signaling and resource utilization are desirable and beneficial.

### SUMMARY

Methods and apparatus for SBFD RACH configuration are described. In some embodiments, existing legacy Radio Resource Control (RRC) Information Elements (IEs), e.g., msg1-Frequency Start and msg-1 FDM, are re-used to signal RACH configuration to SBFD-aware UEs. In some embodiments, new RRC signaling IEs, e.g., msg1-FrequencyStartSBFD-r19, msg1-FDM-SBFD-19, ra-Msg1-RO-FrequencyOffsetSBFD-r19, and/or ra-RO-ScalingFactorSBFD-r19, are introduced specifically for SBFD RACH configuration for SBFD-aware UEs. The RACH configuration will be conveyed to the SBFD UEs via system information block 1 (SIB1), which is transmitted by a base station, e.g. gNB over the DL physical channel PDSCH. The UE reads the RACH configuration upon decoding SIB1.

An exemplary method of operating a base station, in accordance with some embodiments, comprises: generating SIB information corresponding to one or more slots, said one or more slots including a Sub-Band Full Duplex (SBFD) slot including an uplink portion and a downlink portion, said SIB information including frequency information indicating a start frequency of the uplink portion of said SBFD slot available for random access transmissions; and transmitting the SIB information from the base station. An exemplary method of operating a user equipment (UE), in accordance with some embodiments, comprises: receiving System Information Block (SIB) information, corresponding to one or more slots, said one or more slots including a Sub-band full duplex (SBFD) slot including an uplink portion and a downlink portion, said SIB information including frequency information indicating a start frequency of the uplink portion of said SBFD slot available for random access transmissions; and transmitting a Random Access Channel (RACH) signal, e.g., a PRACH signal, in the SBFD slot.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of a prior art 4-step CBRA message sequence in accordance with 3GPP TS38.300.

FIG. 2 is a drawing illustrating encapsulation of a Msg1 RO Frequency Offset Parameter in a System Information Block 1 (SIB1), which illustrates exemplary signaling for SBFD in a manner consistent with 3GPP TS.38.331.

FIG. 3 is a drawing illustrating system information acquisition to obtain RACH-ConfigurationCommon for SBFD in a manner consistent with 3GPP TS 38.331.

FIG. 4 is a drawing of a sample RACH configuration for initial access for a SBFD aware UE.

FIG. 5 is a drawing illustrating a RACH frequency configuration interpretation for initial access for a SBFD-aware UE.

FIG. 6 is a drawing illustrating encapsulation of a Msg1 RO Frequency Offset parameter in SIB1 signaling.

FIG. 7 includes a description of a RACH config parameter ra-Msg1-RO-FrequencyOFfsetSBFD-r19.

FIG. 8 is a drawing illustrating encapsulation of Msg1 RO Frequency Offset parameter in SIB1 signaling, in accordance with an exemplary embodiment.

FIG. 9 is a drawing illustrating encapsulation of a Msg1 RO Frequency Offset parameter in SIB1 signaling in accordance with an exemplary embodiment.

FIG. 10 is a drawing which includes a description of RACH configuration parameter ra-Msg1-RO-FrequencyOffsetSBFD-r19, in accordance with an exemplary embodiment.

FIG. 11 is a drawing which includes a description of msg1-FreqeuncyStart parameter and information describing how a UE determines the frequency offset of the lowest RO in accordance with an exemplary embodiment.

FIG. 12 is a drawing of an exemplary communications system in accordance with an exemplary embodiment.

FIG. 13 is a drawing of an exemplary base station (BS), e.g. a gNB, implemented in accordance with an exemplary embodiment.

FIG. 14 is a drawing of an exemplary user equipment (UE), e.g., a SBFD-aware UE, implemented in accordance with an exemplary embodiment.

FIG. 15 is a drawing of an exemplary UE, e.g., a legacy UE which is a non-SBFD aware UE.

FIG. 16 is a flowchart of an exemplary method of operating a base station in accordance with an exemplary embodiment.

FIG. 17 is a flowchart of an exemplary method of operating a UE, e.g., a SBFD aware UE, in accordance with an exemplary embodiment.

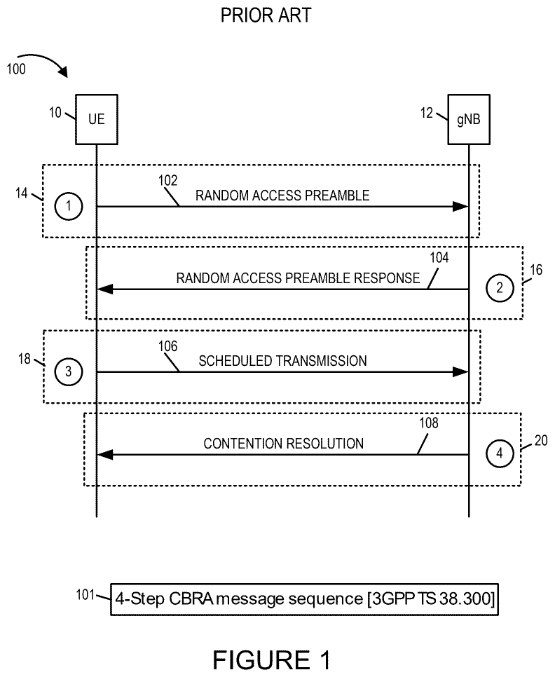

### DETAILED DESCRIPTION

The present invention is directed to methods and apparatus relating to configuration issues relating to supporting and/or using SBFD slots, communicating, e.g., from a base station, SBFD related information and/or to devices receiving slot or other information and using such information, e.g., to support communications in SBFD and/or non-SBFD slots.

For successful MSG1 transmission and consequently successful Random Access Channel (RACH) procedure for initial attach to the network (NW), certain configuration about the frequency/time resources used by the UE to transmit MSG1 must be provided by the network (NW) or base station, e.g., gNB.

Configuring RACH resources for SBFD-aware UEs requires certain careful considerations different or slightly similar to that of non-SBFD (legacy) UEs. SBFD RACH configuration (that is, the frequency reference point/time location for SBFD symbols) should be configured such that the configured RO does not fall outside of the UL available/usable PRBs of the SBFD Uplink (UL) symbols, which in many cases occupy only a small portion of an SBFD slot.

Also, while configuring RACH resources for SBFD-aware UEs, NW need to ensure that no UL frequency fragmentation is caused by the ROs in non-SBFD symbols configured by the additional RACH configuration. 3GPP RAN1 RP-242034, “Evolution of NR duplex operation: Sub-band full duplex (SBFD),” Status report, Huawei, Samsung, which is hereby expressly incorporated by reference, reached agreements on how the SBFD RACH resources can be configured to prevent conflicts between ROs in SBFD symbols and non-SBFD symbols.

The present application furthers the configuration information elements (IEs) or parameters setup and signaling for SBFD RACH configuration options beyond those which were previously agreed to.

Features and aspects of the invention, relating SBFD RACH Configuration Setup, will now be discussed.

In some embodiments, for SBFD-aware UEs, a SBFD-aware UE supports only one RACH configuration and uses the existing RACH configuration parameters to configure frequency offset of the lowest RO. This single RACH configuration can be, and in some embodiments is, based on the existing legacy RACH configuration adapted for SBFD-aware UE capable of using SBFD resources for initial access.

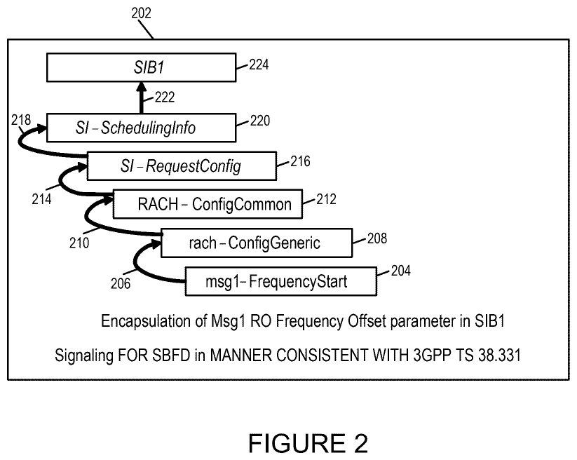

A first aspect (aspect 1), which is used in some embodiments of the invention, will now be discussed. FIG. 2 includes drawing 202, which illustrates encapsulation of a Msg1 RO Frequency Offset parameter in System Information Block 1 (SIB1) signaling for SBFB in a manner consistent with 3GPP TS 38.331. msg1-FrequencyStart 204 is included as part of rach-ConfigGeneric 208, as indicated by arrow 206. rach-ConfigGeneric 208 is included as part of RACH-ConfigCommon 212, as indicated by arrow 210. RACH-ConfigCommon 212 is included as part of SI-RequestConfig 216, as indicated by arrow 214. SI-RequestConfig 216 is included as part of SI-SchedulingInfo 220, as indicated by arrow 218. SI-ScheduingInfo 220 is included as part of SIB1 224, as indicated by arrow 222.

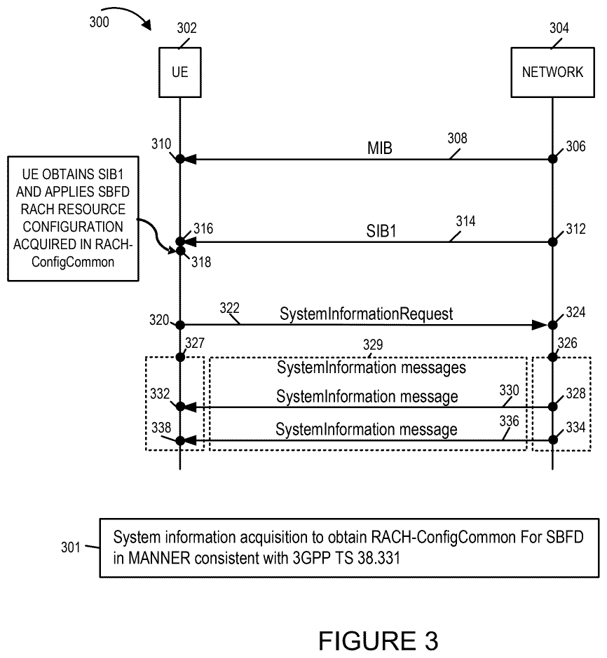

FIG. 3 includes a drawing 300, illustrating system information acquisition to obtain RACH-ConfigurationCommon for SBFD in a manner consistent with 3GPP TS 38.331, as indicated by title block 301. Drawing 300 includes exemplary UE 302 and exemplary network (NW) 304, e.g., a gNB, which exchange signaling conveying MIB, SIB1, a System InformationRequest message, and system information messages. In step 306, network 304 broadcasts Master Information Block (MIB) signals 308 to UEs. In step 310 UE 302 receives MIB signals 308 and recovers the communicated information. In step 312 network 304 broadcasts System Information Block 1 (SIB1) signals 314 to UEs. In step 316 UE 302 receives the SIB1 signals 314. In step 318 UE 302 obtains, e.g., recovers, SIB1 and applies the SBFD RACH resource configuration acquired in RACH-ConfigurationCommon. In step 320 UE 302 generates and sends SystemInformationRequest 322 to network 304. In step 324, network 304 receives System Information Request 322 and recovers the communicated information. In step 326, in response to the received System Information Request from UE 302, network 304, generates and sends SystemInformation messages 329, including System Information message 330 and SystemInformation message 336, to UE 302, which are received by UE 302 in step 327. In step 328 network 304 generates and sends SystemInformation message 330 to UE 302, which is received, by UE 302 in step 322. In step 334 network 304 generates and sends System Information message 336 to UE 302, which is received, by UE 302 in step 338.

For a SBFD-aware UE, the NW 304 configures SBFD RACH resources via a single RACH configuration through SIB1 as shown in FIG. 2 and UE 302 obtains the RACH configuration through SIB1 as shown in FIG. 3, where the existing RACH configuration parameter msg1-FrequencyStart (204) in rach-ConfigCommon (212) is the frequency offset of lowest RO in frequency domain with respect to the lowest PRB of the UL usable PRBs. In some embodiments, this configuration parameter (204) should be implemented as follows for SBFD-aware UEs:

Set the value of msg1-FrequencyStart (204) to the frequency offset of the lowest RO in frequency domain with respect to the lower PRB of UL usable PRBs.

To do this, gNB predetermined the size of UL usable PRBs based on the frequency portion assigned to the legacy RACH. Therefore, the following statement highlighted by using bold text should be added to ra-InformationCommon in [TS 38.331 Section 5.7.10.5]:
2<set the msg1-FrequencyStart associated to the 4 step random-access resources if used in the random-access procedure, and if its value is different from the value of msgA-RO-FrequencyStart if it is included in the ra-InformationCommon;
   3>If msg1-FrequencyStart is configured for SBFD-aware UE, predetermine the UL usable PRBs and set msg1-FrequencyStart offset such that the lowest RO and the corresponding ROs are within the UL usable PRBs.

The above clause will help prevent SBFD RACH operation failure by allowing msg1-FrequencyStart to be configured for SBFD-aware RACH within the SBFD symbols' UL usable PRBs such that the configured ROs for the SBFD-aware UE remain within the usable UL PRBs.

In a second aspect (aspect 2), which is supported in some embodiments, to further prevent invalid ROs when the ROs exceed the UL usable PRBs, adding the following statement, highlighted using bold, to the existing msg1-FDM description in 3 GPP TS 38.211V16.0.0, “NR; Physical channels and modulation (Release 16),” 2020. [TS 38.331] which is hereby expressly incorporated by reference:

msg1-FDM
The number of PRACH transmission occasions FDMed in one time instance. (see TS 38.211, clause 6.3.3.2). For SBFD-aware UE, this number of PRACH transmission occasions should be limited such that all the configured ROs can remain within the UL usable PRBs, eliminating invalid ROs.

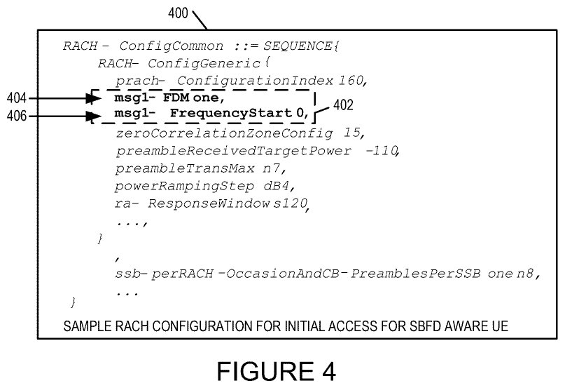

An exemplary SBFD RACH Configuration Setup will now be discussed. For an SBFD-aware UE, the sample RACH configuration 400 of FIG. 4 may be, and sometimes is, assigned for initial access.

Exemplary sample RACH configuration 400 of FIG. 4 includes novel information block 402, as part of the RACH-ConfigGeneric. Information block 402 includes msg1-FDM one 404 and msg1-FrequencyStart 0 406.

Using the exemplary PRACH configuration of FIG. 4, msg1-Frequency Start will point to PRB #0 as the frequency offset and msg1-FDM indicates that there is one RACH Occasion (RO) in one time instance multiplexed in frequency domain. The value is carefully chosen, e.g., by the gNB for SBFD-aware UEs, and communicated to the SBFD aware UEs through signaling, to ensure the ROs are within the UL usable PRBs.

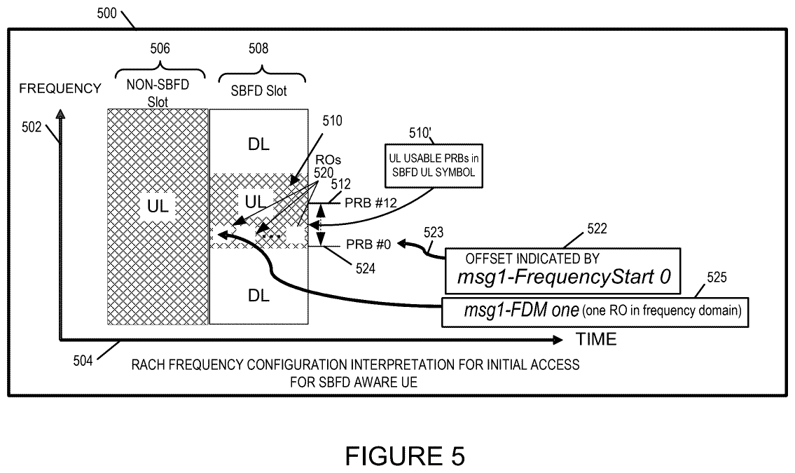

FIG. 5 is a drawing 500 of an exemplary frequency vs time plot illustrating a RACH frequency configuration interpretation for initial access for a SBFD aware UE. In drawing 500, vertical axis 502 represents frequency while horizontal axis 504 represents time. The timing-frequency structure includes a non-SBFD slot 506 which includes uplink UL resources and a SBFD slot 508, which includes downlink (DL) resources and UL resources. SBFD slot 508 includes UL resources 510. UL resources 510 includes a portion 510′, which represents UL usable PRBs in a SBFD UL symbol corresponding to SBFD slot 508. Portion 510′ is bounded in the frequency domain by lower frequency 524, corresponding to PRB #0 and upper frequency 512, corresponding to PRB #12. Small white squares 520 represent ROs.

The msg1-Frequency Start, with the value of 0, will point to PRB #0 as the frequency offset, as indicated by information box 522 and arrow 523. The msg1-FDM with a value of one (see information box 525) indicates that there is one RACH Occasion (RO) in one time instance multiplexed in the frequency domain.

The above discussed configuration approach allowed signaling messages to be used which are the same or similar to those currently in use but with the information in the msg1-FrequencyStart being selected by the gNB and/or interpreted by a UE receiving the information in a manner that results in the start frequency indicated in the frequency offset message falling in the SBFD slot resources which are available for uplink signaling in the SBFD slot to which the configuration information relates. The number of RACH occasions will also be set to a value which limits the number of RACH occasions, and thus the potential increase in the frequency/resource range that may be used in sequential RACH occasions, to remain within the range of available uplink resources in an SBFD slot.

Often the set of resources in an SBFD slot available for uplink signaling is a smaller fraction of the resources of a slot, e.g., less than ⅓ of the slot resources, than the resources available for uplink signaling in a non-SBFD uplink slot.

Accordingly, in various embodiments a gNB signals a different msg1-FrequencyStart in a message relating to a non-SBFD slot and/or a UE receiving a msg1-Frequency Start of 0 will interpret it differently depending on whether it relates to a non-SBFD slot or an SBFD slot. For example, in some embodiments a msg1-FrequencyStart of 0 indicated with regard to a non-SBFD slot will refer to the lowest frequency of a non-SBFD while a msg1-Frequency Start of 0 in msg1 which relates to an SBFD slot will correspond to the lowest frequency available in the SBFD slot for UL signaling, which in at least some cases is not the lowest frequency in the SBFD slot.

Thus, in some embodiments RACH configuration information sent to a UE which is to non-SBFD enabled or SBFD enabled device will indicate or refer to a lower start frequency for RACH communications in a non-SBFD uplink slot than the start frequency which is signaled or understood by a receiving device for SBFD slot information relating to a SBFD slot. Similarly, because of the larger range of available uplink resources in a non-SBFD slot, the number of RACH occasions indicated for a non-SBFD uplink slot is sometimes larger than the number of RACH occasions indicated for a SBFD slot.

In various embodiments a UE which is non-SBFD enabled is able to use RACH resources in non-SBFD slots but not RACH resources in SBFD slots. A SBFD enabled device can normally use RACH resources in non-SBFD slots and SBFD slots.

In the above described manner similar signaling can be used to start frequency and number of RACH occasions permitted in non-SBFD slots and SBFD slots but with the range of RACH occasions and/or start frequency being different for non-SBFD slots and SBFD slots to ensure that UE devices using RACH resources in SBFD slots do not access or use downlink resources in the SBFD slots for uplink signaling, e.g., UE RACH transmissions.

In accordance with a third aspect (aspect 3) of the invention, used in some but not necessarily all embodiments, a new information element, e.g., msg1-Frequency StartSBFD-r19, is used by the base station to communicate the start frequency offset for a RACH Occasion (RO) which is a UE opportunity to send a Physical Random Access Channel (PRACH) transmission.

For example, in a case where msg1-FrequencyStart cannot be used for SBFD-aware UE RACH configuration, as proposed in accordance with aspect 1 of the invention, e.g., due to conflicts with a legacy RACH configuration, a new information element, e.g., msg1-Frequency StartSBFD-r19, can be, and sometimes is, used to convey the configuration RO offset. To add support for this information element, the following clause is added to the description of msg1-FrequencyStartSBFD-r19 in 3 GPP TS 38.331 V18.1.0, “Radio Resource Control (RRC) protocol specification,” 2024, [TS 38.331], which is hereby expressly incorporated by reference in its entirety:

### Msg1-FrequencyStartSBFD-r19

If present in rach-ConfigCommon and UE is SBFD-aware, the value of this field is the offset of lowest PRACH transmission occasion in frequency domain with respective to PRB 0 in the UL usable PRBs. The value is configured so that the corresponding RACH resource is entirely within the bandwidth of the UL BWP. (see 3GPP TS 38.211V16.0.0, “NR; Physical channels and modulation (Release 16),” 2020, clause 6.3.3.2).

When msg1-FrequencyStartSBFD-r19 is present or used, define msg1-FDM-SBFDr19 to further prevent invalid ROs when the ROs exceed the UL usable PRBs. In accordance with the invention, the following description of msg1-FDM-SBFD-r19 is added in 3 GPP TS 38.331 V18.1.0, “Radio Resource Control (RRC) protocol specification,” 2024:

### Msg1-FDM-SBFD-r19

If present and UE is SBFD-aware, this field represents the number of PRACH transmission occasions FDMed in one time instance. Its value should be limited such that all the configured ROs can remain within the UL usable PRBs, eliminating invalid ROs.

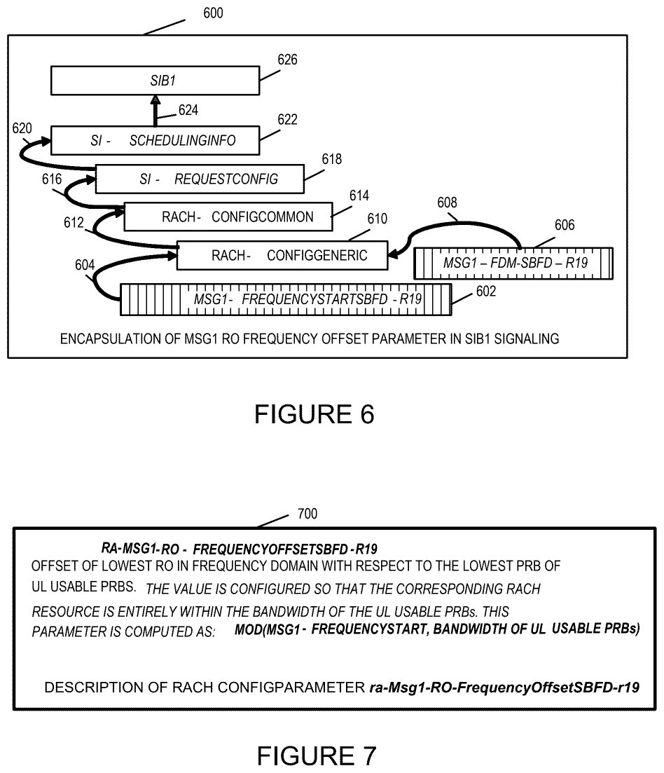

The two above parameters (msg1-FrequencyStartSBFD-r19 and msg1-FDM-SBFD-r19) shall be SBFD specific and will distinguish PRACH transmissions on SBFD symbols from that of legacy non-SBFD resources, since they will indicate exact offset and configured ROs within the SBFD symbols and prevent confusion between the legacy RACH resource and SBFD RACH resource indicators at the UE. These IEs (msg1-Frequency StartSBFD-r19 and msg1-FDM-SBFD-r19) are encapsulated in the rach-ConfigGeneric as shown in FIG. 6.

FIG. 6 includes drawing 600, which illustrates encapsulation of a Msg1 RO Frequency Offset parameter in System Information Block 1 (SIB1) signaling for SBFD in accordance with an exemplary embodiment. msg1-FrequencyStartSBFD-r19 602 is included as part of rach-ConfigGeneric 610, as indicated by arrow 604. msg1-FDM-SBFD-r19 606 is included as part of rach-ConfigGeneric 610, as indicated by arrow 608. rach-ConfigGeneric 610 is included as part of RACH-ConfigCommon 614, as indicated by arrow 612. RACH-ConfigCommon 614 is included as part of SI-RequestConfig 618, as indicated by arrow 616. SI-RequestConfig 618 is included as part of SI-SchedulingInfo 622, as indicated by arrow 620. SI-ScheduingInfo 622 is included as part of SIB1 626, as indicated by arrow 624.

By modifying the above noted standards as described, devices, e.g., SBFD aware UEs, can comply with the revised standard and use the new information element(s).

The two above parameters (msg1-FrequencyStartSBFD-r19 and msg1-FDM-SBFD-r19) to be added to the standard(s) shall be SBFD specific and will distinguish PRACH transmissions on SBFD symbols from that of legacy non-SBFD resources, since they will indicate exact offset and configured ROs within the SBFD symbols and prevent confusion between the legacy RACH resource and SBFD RACH resource indicators at the UE. These IEs (msg1-FrequencyStartSBFD-r19 602 and msg1-FDM-SBFD-r19 606) are encapsulated in the rach-ConfigGeneric 610 as shown in drawing 600 FIG. 6.

Aspects relating to SBFD RACH Configuration Setup, used on some embodiments, will now be discussed.

In accordance with what will be referred to as invention aspect 4, the existing RACH configuration parameter msg1-FrequencyStart in 3GPP TS 38.331 V18.1.0, “Radio Resource Control (RRC) protocol specification,” 2024 is reused as a new RO offset parameter when used with regard to SBFD slots which is defined as follows:
Given the bandwidth of the UL usable PRBs and msg1-FrequencyStart, the frequency offset of lowest RO in frequency domain with respect to the lowest PRB of UL usable PRBs is equal to mod (msg1-FrequencyStart, bandwidth of UL usable PRBs).
For this case, given the value msg1-FrequencyStart and the bandwidth of the UL usable PRBs, we define ra-Msg1-RO-FrequencyOffsetSBFD-r19 whose value is set as mod (msg1-FrequencyStart, bandwidth of UL usable PRBs), and described in drawing 700 FIG. 7.

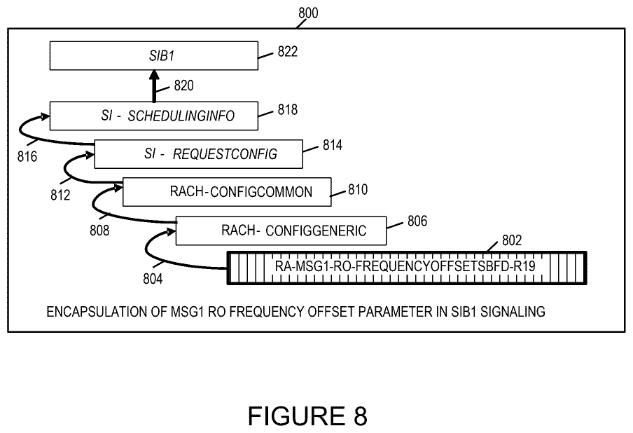

This new RACH configuration parameter (ra-Msg1-RO-FrequencyOffsetSBFD-r19) shall be cell-specific and applies to SBFD-aware UEs within the cell. Therefore, this RACH parameter ra-RO-FrequencyOffsetSBFD-r19 should be added to the parameter rach-ConfigGeneric, which is encapsulated in RACH-ConfigCommon as shown in FIG. 8, where the RACH configuration is finally encapsulated in SIB1. Add the parameter description in FIG. 7 to the rach-ConfigGeneric parameters descriptions in 3GPP TS 38.331 V18.1.0, “Radio Resource Control (RRC) protocol specification,” 2024.

FIG. 8 includes drawing 800, which illustrates encapsulation of a Msg1 RO Frequency Offset parameter in System Information Block 1 (SIB1) signaling for SBFD in accordance with an exemplary embodiment. Ra-Msg1-FrequencyOffsetSBFD-r19 802 is included as part of rach-ConfigGeneric 806, as indicated by arrow 804. rach-ConfigGeneric 806 is included as part of RACH-ConfigCommon 810, as indicated by arrow 808. RACH-ConfigCommon 810 is included as part of SI-RequestConfig 814, as indicated by arrow 812. SI-RequestConfig 814 is included as part of SI-SchedulingInfo 818, as indicated by arrow 816. SI-ScheduingInfo 818 is included as part of SIB1 822, as indicated by arrow 820.

An alternative approach to SBFD RACH Configuration Setup will now be discussed. With what will be referred to as aspect 5 of the invention, if ra-RO-FrequencyOffsetSBFD-r19 is not defined as a new information element (IE) to convey the configuration RO offset as per aspect 4, the following clause is added to the description of msg1-Frequency Start in defined in 3GP TS 38.331 V18.1.0, “Radio Resource Control (RRC) protocol specification,” 2024 and devices are operated in accordance with the following clause:

### Msg1-FrequencyStart

Offset of lowest PRACH transmission occasion in frequency domain with respective to PRB 0. The value is configured so that the corresponding RACH resource is entirely within the bandwidth of the UL BWP. (see TS 38.211 [16], clause 6.3.3.2). For SBFD-aware UEs, the value of msg1-FrequencyStart is used to determine the frequency offset of the lowest RO as mod (msg1-FrequencyStart, bandwidth of UL usable PRBs).

Also, to further prevent invalid ROs when the ROs exceed the UL usable PRBs, adding the following highlighted statement to the existing msg1-FDM description in 3GPP TS 38.331 V18.1.0:

msg1-FDM
The number of PRACH transmission occasions FDMed in one time instance. (see TS 38.211 [16], clause 6.3.3.2). For SBFD-aware UE, this number of PRACH transmission occasions should be limited such that all the configured ROs can remain within the UL usable PRBs, eliminating invalid ROs.

Additional features used in some embodiments relating to SBFD RACH Configuration Setup will now be discussed. In some embodiments a scaling factor is used. In accordance with what will be referred to as aspect 6, a scaling factor (SF) is used in determining the frequency offset of the lowest RO in frequency domain with respect to the lowest PRB of UL usable PRB in a SBFD slot, where the frequency offset (FO) of the lowest RO in frequency domain with respect to the lowest PRB of UL usable PRB is defined as:

$$FO of lowest RO = ( msg 1 - FrequencyStart ) times ( scaling factor )$$

$$where scaling factor = \frac{UL usable PRB size}{UL BWP size}$$

As an alternative to setting the RACH configuration parameter ra-Msg1-RO-FrequencyOffsetSBFD-r19 frequency offset of the RO as discussed above with regard to aspects 2 and 3, a scaling factor is used in some embodiments to determine this offset.

In accordance with this aspect of the invention a new RACH configuration parameter ra-RO-ScalingFactorSBFD-r19 is defined to communicate the scaling factor.

In one embodiment ra-RO-ScalingFactorSBFD-r19 is set to:

$$\frac{UL usable PRB size}{UL BWP size}$$

where the UL usable PRB size and the UL BWP size are known from the UL BWP configuration.

Thus, in some embodiments:

$$ra - RO - ScalingFactorSBFD - r 19 = \frac{UL usable PRB size}{UL BWP size}$$

In such embodiments, given an existing RACH configuration parameter msg1-FrequencyStart, the frequency offset of the RO parameter ra-Msg1-RO-FrequencyOffsetSBFD-r19 for SBFD-aware UE RACH becomes:

$$ra = Msg 1 - RO - FrequencyOffsetSBFD - r 19 = ra - RO - ScalingFactorSBFD - r 19 * msg 1 - FrequencyStart ,$$

where * is used to indicate a multiply operation.

To support such functionality, the parameter description for RACH config parameter: ra-Msg1-RO-FrequencyOffsetSBFD-r19, as shown drawing 928 in FIG. 10 is added to the rach-ConfigGeneric parameters descriptions in 3GPP TS 38.331 V18.1.0, “Radio Resource Control (RRC) protocol specification,” 2024.

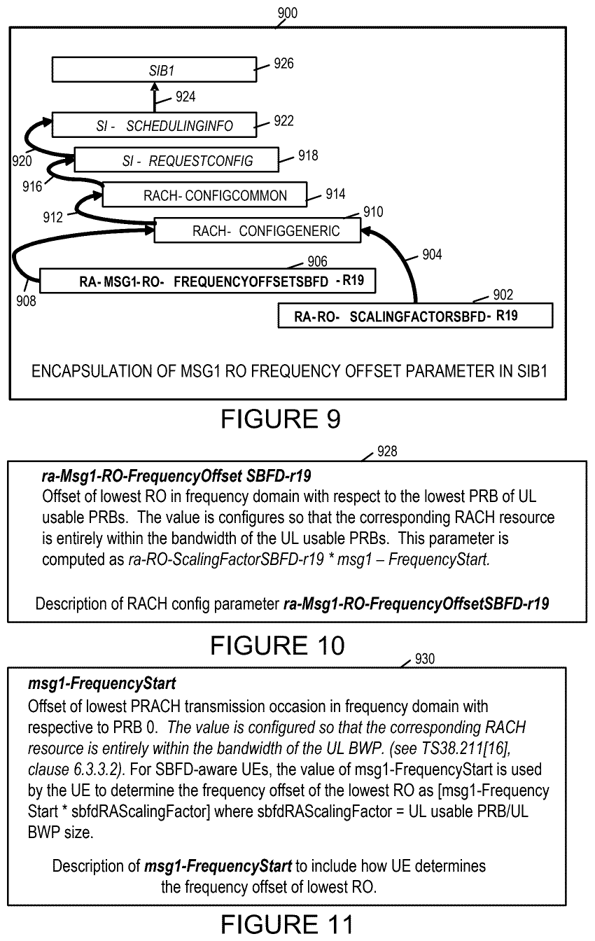

This RACH configuration parameter (ra-Msg1-RO-FrequencyOffsetSBFD-r19) can be, and sometimes is, signaled to the UE via SIB1 as shown in drawing 900 FIG. 9, with the SIB1 being transmitted by a base station to provide configuration information to devices.

FIG. 9 includes drawing 900, which illustrates encapsulation of a Msg1 RO Frequency Offset parameter in System Information Block 1 (SIB1) in accordance with an exemplary embodiment. ra-RO-ScalingFactorSBFD-r19 902 may be, and sometimes is, included as part of rach-ConfigGeneric 910, as indicated by arrow 904. ra-Msg1-FrequencyOffsetSBFD-r19 906 may be, and sometimes is, included as part of rach-ConfigGeneric 910, as indicated by arrow 908. rach-ConfigGeneric 910 is included as part of RACH-ConfigCommon 914, as indicated by arrow 912. RACH-ConfigCommon 914 is included as part of SI-RequestConfig 918, as indicated by arrow 916. SI-RequestConfig 918 is included as part of SI-SchedulingInfo 922, as indicated by arrow 920. SI-ScheduingInfo 922 is included as part of SIB1 926, as indicated by arrow 924.

Various embodiments can support and use the new scaling factor in different ways.

In accordance with one aspect of the invention, referred to as aspect 6-1: a gNB pre-calculates ra-RO-ScalingFactorSBFD-r19 902 and includes it in rach-ConfigGeneric 910 and then lets a UE determine the value of ra-Msg1-RO-FrequencyOffsetSBFD-r19 when applying the RACH configuration parameters. Accordingly, a UE, e.g., a SBFD-aware UE, determines the value of ra-Msg1-RO-FrequencyOffsetSBFD-r19 in one such embodiment.

In accordance with another aspect of the invention, referred to as aspect 6-2 a base station, e.g., gNB, predetermines the value of ra-Msg1-RO-FrequencyOffsetSBFD-r19 906 and includes it in rach-ConfigGeneric 910 and there is no need to send ra-RO-ScalingFactorSBFD-r19 to the UE, since the base station communicates it to the UE. This option is suitable if the size of the UL usable PRB is predetermined at configuration time and only ra-Msg1-RO-FrequencyOffsetSBFD-r19 906 is included in SIB1.

In accordance with another aspect of the invention, referred to as aspect 6-3: gNB provides only the value of msg1-FrequencyStart 930 and leaves the determination of frequency offset to the UE. The UE, e.g., a SBFD-aware UE, then determines the frequency offset. In this case, the clause, shown in drawing 930 of FIG. 11, is added to the description of msg1-Frequency Start parameter in 3GPP TS 38.331 V18.1.0, “Radio Resource Control (RRC) protocol specification,” 2024.

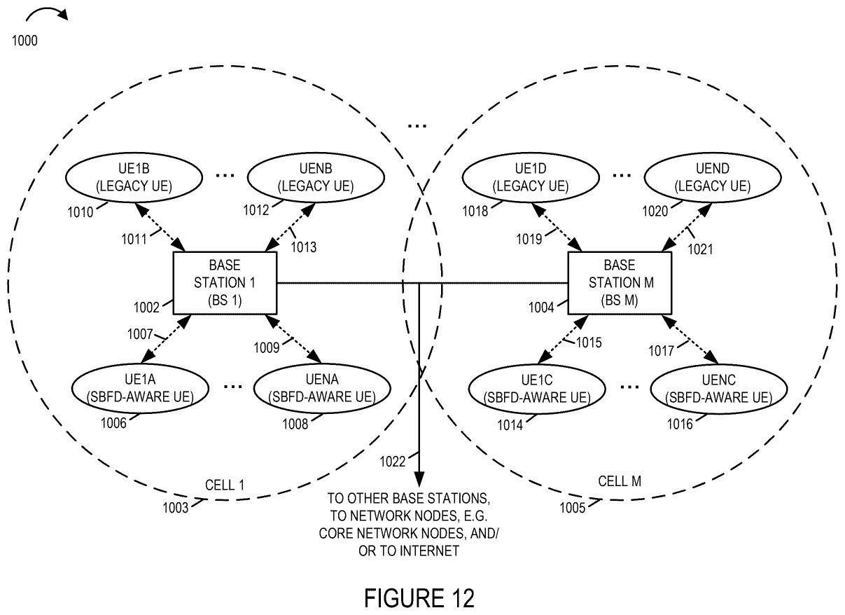

FIG. 12 is a drawing of an exemplary communications system 1000 in accordance with an exemplary embodiment. Exemplary communications system 1000 includes a plurality of base stations (base station 1 (BS 1) 1002, . . . , base station M (BS M) 1004) coupled together, to network nodes, e.g., to 5G core network nodes, and/or to the Internet via communications backhaul link(s) 1022. Exemplary communications system 1000 further includes a plurality of user equipments (UEs) (UE1A 1006, . . . , UENA 1008, UE1B 1010, . . . , UENB 1012, UE1C 1014, . . . , UENC 1016, UEID 1018, . . . , UEND 1020). At least some of the UEs are mobile wireless devices which may move throughout system 100 and be connected to different base stations at different time. Some of the UEs are SBFD-aware UEs, while other UEs are legacy UEs. UE1A 1006, UENA 1008, UE1C 1014, and UENC 1016 are SBFD-aware UEs. UE1B 1010, UENB 1012, UE1D 1018, and UEND 1020 are legacy UEs.

Base station 1 (BS 1) 1002 has a corresponding cellular coverage area 1003. UEs (1006, 1008, 1010 and 1012 are currently located within cellular coverage area 1003. UE1A 1006 is coupled to BS 1 1002 via wireless connection 1007. UENA 1008 is coupled to BS 1 1002 via wireless connection 1009. UE1B 1010 is coupled to BS 1 102 via wireless connection 1011. UENB 1012 is coupled to BS 1 1002 via wireless connection 1013.

Base station M (BS M) 1004 has a corresponding cellular coverage area 1005. UEs (1014, 1016, 1018 and 1020 are currently located within cellular coverage area 1005. UE1C 1014 is coupled to BS M 1004 via wireless connection 1015. UENC 1016 is coupled to BS M 1004 via wireless connection 1017. UEID 1018 is coupled to BS M 1004 via wireless connection 1019. UEND 1020 is coupled to BS M 1004 via wireless connection 1021.

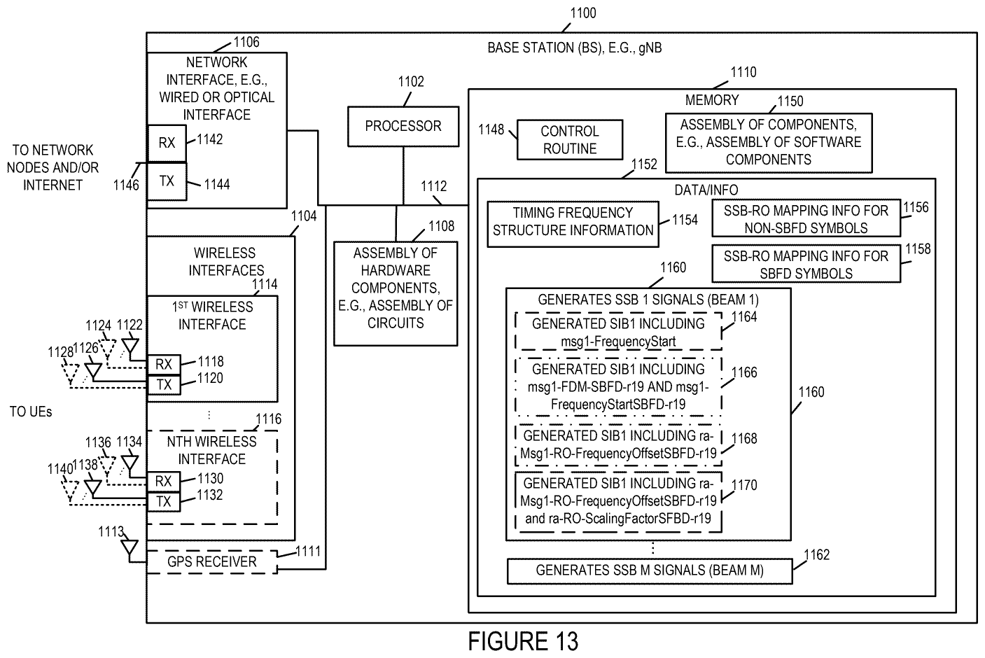

FIG. 13 is a drawing of an exemplary base station 1100, e.g., a gNB, in accordance with an exemplary embodiment. Exemplary base station 1100 is, e.g., BS 1 1002 or BS M 1004 of system 1000 of FIG. 12. Exemplary base station 1100 includes a processor 1102, e.g., a CPU, wireless interfaces 1104, a network interface 1106, an assembly of hardware components 1108, e.g., an assembly of circuits, and memory 1110 coupled together via bus 1112 over which the various elements may interchange data and information. In some embodiments, base station 1200 further includes a GPS receiver 1111 coupled to bus 1112.

Wireless interfaces 1104 includes one or more wireless interfaces (1st wireless interface 1114, . . . . Nth wireless interface 1116). 1st wireless interface 1114 includes wireless receiver 1118 and wireless transmitter 1120. Wireless receiver 1118 is coupled to one or more receiver antennas (1122, . . . , 1124) via which the base station 1100 receives wireless uplink signals from UEs. Wireless transmitter 1120 is coupled to one or more transmit antennas (1126, . . . , 1128) via which the base station 1100 transmits wireless downlink signals to UEs. In some embodiments one or more antennas are used by both the receiver 1118 and transmitter 1120. Nth wireless interface 1116 includes wireless receiver 1130 and wireless transmitter 1132. Wireless receiver 1130 is coupled to one or more receive antennas (1134, . . . , 1136) via which the base station 1100 receives wireless uplink signals from UEs. Wireless transmitter 1132 is coupled to one or more transmit antennas (1138, . . . , 1140) via which the base station 1100 transmits wireless downlink signals to UEs. In some embodiments one or more antennas are used by both the receiver 1130 and transmitter 1132. In some embodiments different wireless interfaces correspond to different communications bands, different spectrum, and/or different communications protocols.

Network interface 1106, e.g., a wired or optical interface, includes receiver 1142, transmitter 1144 and connector 1146. Network interface 1106 couples the base station 1100 to network nodes, e.g., other base stations, core network nodes, e.g., 5G core network nodes, and/or the Internet.

GPS receiver 1111 is coupled to GPS receive antenna 1113. GPS signals, received via GPS receive antenna 1113, are processed by the GPS receiver 1111 to determine time, position, e.g. latitude, longitude and altitude, and velocity information. In some embodiment the GPS receiver 1111 is used to facilitate a precise placement of the base station 1100, e.g., as part of an installation process.

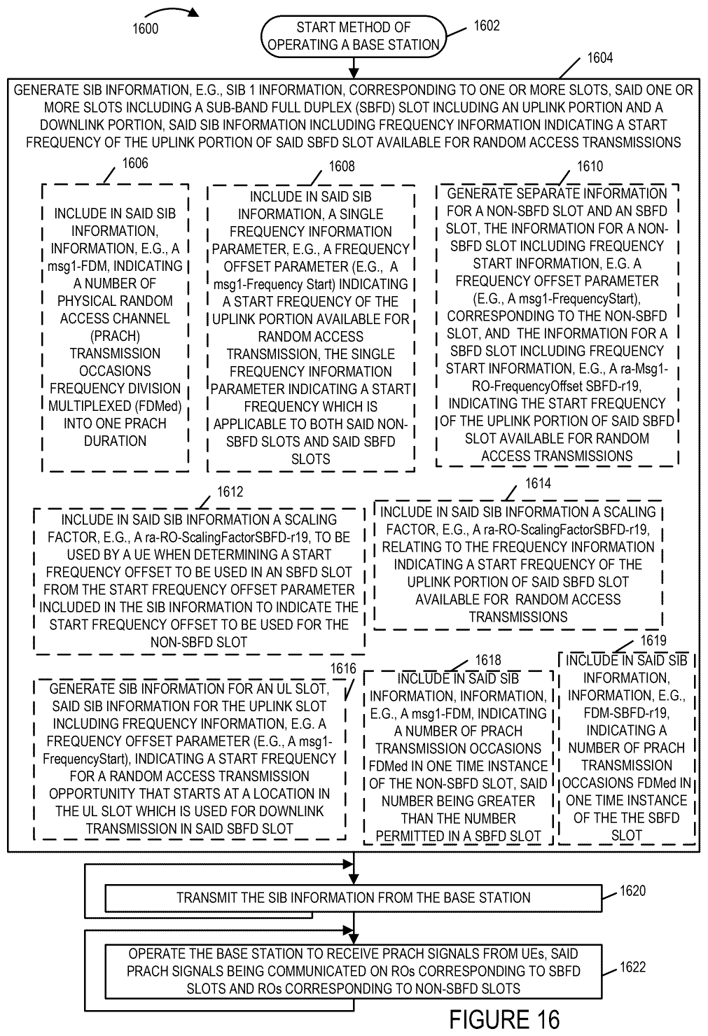

Memory 1110 includes a control routine 1148, an assembly of components 1150 and data/information 1152. Control routine 1148 includes instructions which when executed by processor 1102 control the base station 1100 to implement basic operational functions, e.g., read memory, write to memory, control an interface, load a program, subroutine, or app, etc. Assembly of components 1150, e.g., an assembly of software components, e.g., routines, subroutines, applications, etc., includes, e.g., code, e.g., machine executable instructions, which when executed by processor 1102, controls the base station 1100 to implement steps of a method in accordance with the present invention, e.g., steps of the method of flowchart 1600 of FIG. 16. Data/information 1152 includes timing-frequency structure information 1154, said timing-frequency structure, being implemented by base station 1100 includes non-SBFD slots, each non-SBFD slot including one or more non-SBFD symbols and SBFD slots, each SBFD slot including one or more SBFD symbols. Data/information 1152 includes timing-frequency structure information 1154, SSB-RO mapping information for non-SBFD symbols 1156, SSB-RO mapping information for SBFD symbols 1158 and generated Synchronization Signal Block (SSB) signals for a plurality of beams (generated SSB 1 signals 1160 corresponding to beam 1, . . . , generated SSB M signals 1162 corresponding to beam M). SSB 1 information 1160 includes, in some embodiments, a generated SIB1 including a msg1-FrequencyStart 1164. SSB 1 information 1160 includes, in some embodiments, a generated SIB1 including a msg1-FDM-SBFD-r19 and a msg1-FrequencyStartSBFD-r19 1166. SSB 1 information 1160 includes, in some embodiments, a generated SIB 1 including a Msg1-RO-FrequencyOffsetSBFD-r19 1168. SSB 1 information 1160 includes, in some embodiments, a generated SIB1 including a ra-RO-FrequencyOffset SBFD-r19 and a ra-RO-ScalingFactorSFBD-r19 1170.

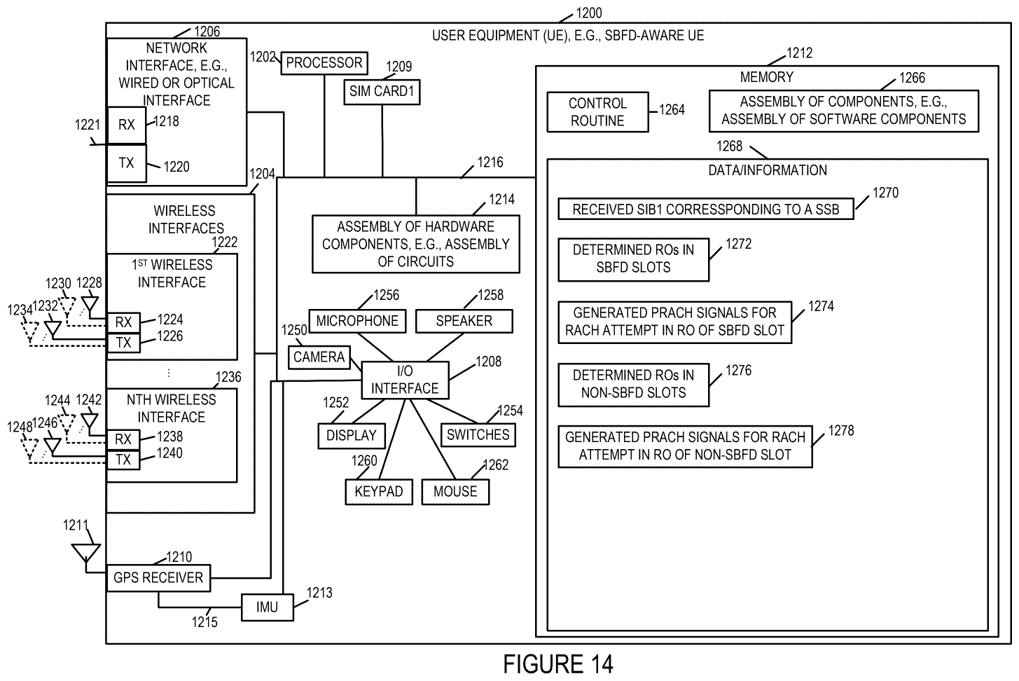

FIG. 14 is a drawing of an exemplary user equipment (UE) 1200, e.g., a SBFD-aware UE, in accordance with an exemplary embodiment. Exemplary UE 1200 of FIG. 14 is, e.g., any of UEs (1006, 1008, 1014, 1016) of system 1000 of FIG. 12.

Exemplary UE 1200 includes a processor 1202, e.g., a CPU, wireless interfaces 1204, a network interface 1206, e.g., a wired or optical interface, I/O interface 1208, GPS receiver 1210, inertial measurement unit (IMU) 1213, and assembly of hardware components 1214, e.g., an assembly of circuits, coupled together via bus 1216 over which the various elements may interchange data and information. In various embodiments, UE 1200 further includes SIM card 1 1209 coupled to bus 1216.

Wireless interfaces 1204 includes a plurality of wireless interfaces (1st wireless interface 1222, . . . , Nth wireless interface 1236). 1st wireless interface 1222 includes wireless receiver 1224 and wireless transmitter 1226. Wireless receiver 1224 is coupled to one or more receiver antennas (1228, . . . , 1230) via which the UE 1200 receives wireless downlink signals from base stations. Wireless transmitter 1226 is coupled to one or more transmit antennas (1232, . . . , 1234) via which the UE 1200 transmits wireless uplink signals to base stations. In some embodiments one or more antennas are used by both the receiver 1224 and transmitter 1226. Nth wireless interface 1236 includes wireless receiver 1238 and wireless transmitter 1240. Wireless receiver 1238 is coupled to one or more receive antennas (1242, . . . , 1244) via which the UE 1200 receives wireless downlink signals from base stations. Wireless transmitter 1240 is coupled to one or more transmit antennas (1246, . . . , 1248) via which the UE 1200 transmits wireless uplink signals to base stations. In some embodiments one or more antennas are used by both the receiver 1238 and transmitter 1240. In some embodiments different wireless interfaces correspond to different communications bands, different spectrum, and/or different communications protocols.

Network interface 1206, e.g., a wired or optical interface, includes receiver 1218, transmitter 1220 and connector 1221. Network interface 1206 may, and sometimes does, couple UE 1200 to base stations, network nodes and/or the Internet, e.g., when the UE 1200 is stationary and located at a site with a wireline and/or optical connection.

GPS receiver 1210 is coupled to GPS antenna 1211. GPS receiver 1210 is further coupled to IMU 1213, e.g., an IMU on a chip including gyroscopes and accelerometers. GPS signals, received via GPS receive antenna 1211, are processed by the GPS receiver 1210 to determine time, position, e.g. latitude, longitude and altitude, and velocity information of UE 1200. In some embodiments, information from IMU 1213, e.g., accelerometer and/or gyroscopes measurements over time, are used, in conjunction with or in place of GPS measurements to determine position, e.g. latitude, longitude and altitude, and velocity information of UE 1200. SIM card 1 1209 includes information corresponding to a first communications network operator to which the owner of UE 1200 is a subscriber.

UE 1200 further includes a plurality of I/O devices (camera 1250, display 1252, e.g., a touch screen display, switches 1254, microphone 1256, speaker 1258, keypad 1260 and mouse 1262) coupled to I/O interface 1208, which couples the various I/O devices to other elements of the UE 1200 via bus 1216.

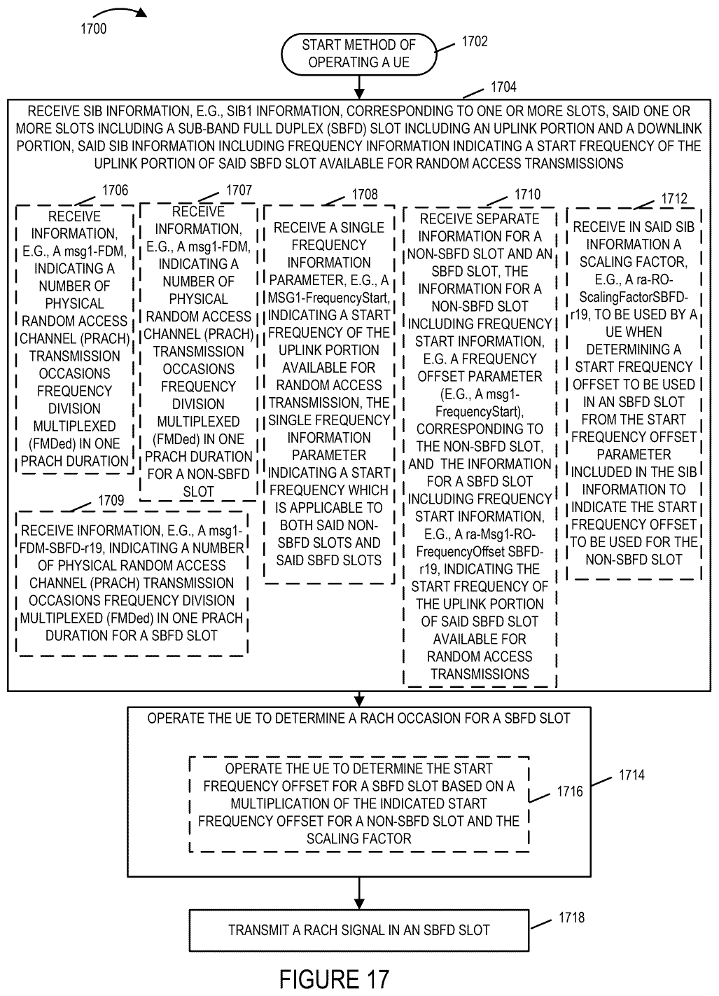

Memory 1212 includes a control routine 1264, an assembly of components 1266, e.g., an assembly of software components, and data/information 1268. Control routine 1264 includes instructions which when executed by processor 1202 control the UE 1200 to implement basic operational functions, e.g., read memory, write to memory, control an interface, load a program, subroutine, or app, etc. Assembly of components 1266, e.g., an assembly of software components, e.g., routines, subroutines, applications, etc., includes, e.g., code, e.g., machine executable instructions, which when executed by processor 1202, controls the UE 1200 to implement steps of a method in accordance with an exemplary embodiment of the present invention, e.g. steps of the method of flowchart 1700 of FIG. 17. Data/information 1268 includes a received SIB1 corresponding to a SSB 1270, determined ROs in SBFD slots 1272, which may be used by the UE 1200, determined ROs in non-SBFD slots 1276, which may be used by UE 1200, generated PRACH signals 1274 for a RACH attempt in RACH occasion (RO) of SBFD slot, and generated PRACH signals 1278 for a RACH attempt in RACH occasion (RO) of a non-SBFD slot.

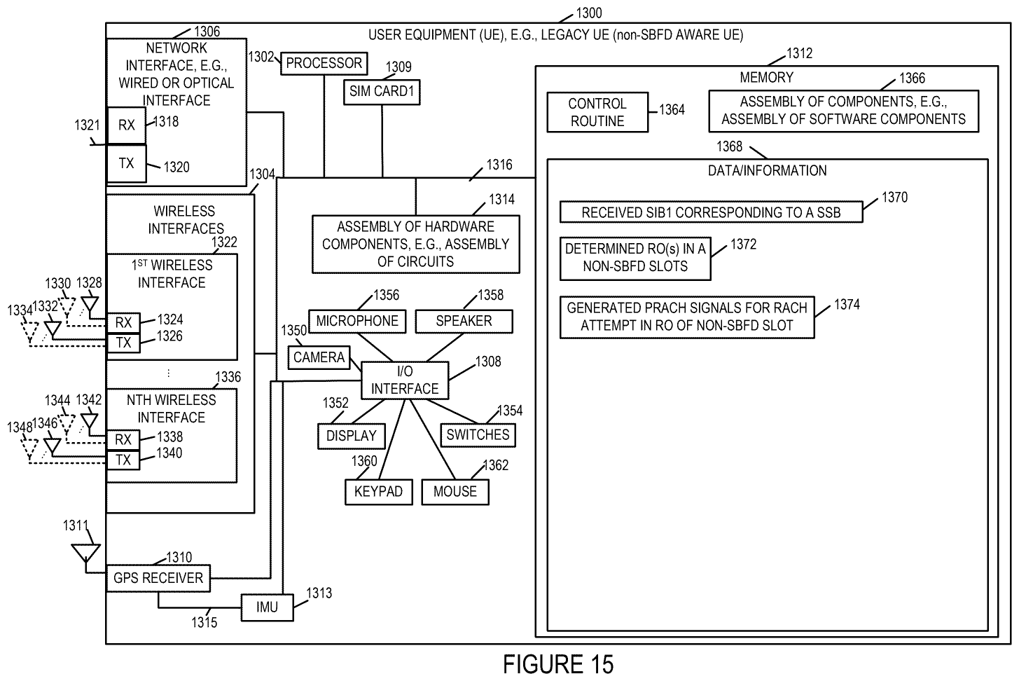

FIG. 15 is a drawing of an exemplary user equipment (UE) 1300, e.g., a legacy UE, in accordance with an exemplary embodiment. Exemplary UE 1300 of FIG. 15 is, e.g., any of UEs (1010, 1012, 1018, 1020) of system 1000 of FIG. 12.

Exemplary UE 1300 includes a processor 1302, e.g., a CPU, wireless interfaces 1304, a network interface 1306, e.g., a wired or optical interface, I/O interface 1308, GPS receiver 1310, inertial measurement unit (IMU) 1313, and assembly of hardware components 1314, e.g., an assembly of circuits, coupled together via bus 1316 over which the various elements may interchange data and information. In various embodiments, UE 1300 further includes SIM card 1 1309 coupled to bus 1316.

Wireless interfaces 1304 includes a plurality of wireless interfaces (1st wireless interface 1322, . . . , Nth wireless interface 1336). 1st wireless interface 1322 includes wireless receiver 1324 and wireless transmitter 1326. Wireless receiver 1324 is coupled to one or more receiver antennas (1328, . . . , 1330) via which the UE 1300 receives wireless downlink signals from base stations. Wireless transmitter 1326 is coupled to one or more transmit antennas (1332, . . . , 1334) via which the UE 1300 transmits wireless uplink signals to base stations. In some embodiments one or more antennas are used by both the receiver 1324 and transmitter 1326. Nth wireless interface 1336 includes wireless receiver 1338 and wireless transmitter 1340.

Wireless receiver 1338 is coupled to one or more receive antennas (1342, . . . , 1344) via which the UE 1300 receives wireless downlink signals from base stations. Wireless transmitter 1340 is coupled to one or more transmit antennas (1346, . . . , 1348) via which the UE 1200 transmits wireless uplink signals to base stations. In some embodiments one or more antennas are used by both the receiver 1338 and transmitter 1340. In some embodiments different wireless interfaces correspond to different communications bands, different spectrum, and/or different communications protocols.

Network interface 1306, e.g., a wired or optical interface, includes receiver 1318, transmitter 1320 and connector 1321. Network interface 1306 may, and sometimes does, couple UE 1300 to base stations, network nodes and/or the Internet, e.g., when the UE 1300 is stationary and located at a site with a wireline and/or optical connection.

GPS receiver 1310 is coupled to GPS antenna 1311. GPS receiver 1310 is further coupled to IMU 1313, e.g., an IMU on a chip including gyroscopes and accelerometers. GPS signals, received via GPS receive antenna 1311, are processed by the GPS receiver 1310 to determine time, position, e.g. latitude, longitude and altitude, and velocity information of UE 1300. In some embodiments, information from IMU 1313, e.g., accelerometer and/or gyroscopes measurements over time, are used, in conjunction with or in place of GPS measurements to determine position, e.g. latitude, longitude and altitude, and velocity information of UE 1300. SIM card 1 1309 includes information corresponding to a first communications network operator to which the owner of UE 1300 is a subscriber.

UE 1300 further includes a plurality of I/O devices (camera 1350, display 1352, e.g., a touch screen display, switches 1354, microphone 1356, speaker 1358, keypad 1360 and mouse 1362) coupled to I/O interface 1308, which couples the various I/O devices to other elements of the UE 1300 via bus 1316.

Memory 1312 includes a control routine 1364, an assembly of components 1366, e.g., an assembly of software components, and data/information 1368. Control routine 1364 includes instructions which when executed by processor 1302 control the UE 1300 to implement basic operational functions, e.g., read memory, write to memory, control an interface, load a program, subroutine, or app, etc. Assembly of components 1366, e.g., an assembly of software components, e.g., routines, subroutines, applications, etc., includes, e.g., code, e.g., machine executable instructions, which when executed by processor 1302, controls the UE 1300 to implement steps of a method in accordance with an exemplary embodiment of the present invention. Data/information 1368 includes a received SIB1 corresponding to a SSB 1370, determined ROs in non-SBFD slots 1372, which may be used by UE 1300, and generated PRACH signals 1374 for a RACH attempt in RACH occasion (RO) of a non-SBFD slot.

FIG. 16 is a flowchart 1600 of an exemplary method of operating a base station (BS), e.g., a gNB, in accordance with an exemplary embodiment. The base station, implementing the flowchart 1600 of FIG. 16, is, e.g., any of the base stations (BS1 102, . . . , BS M 104) of system 1000 of FIG. 12, base station 1100 of FIG. 13, or a base station, implemented in accordance with features of the present invention, supporting random access transmissions in both SBFD slots and non-SBFD slots.

Operation of the exemplary method starts in step 1602, in which the base station is powered on and initialized. Operation proceeds from start step 1602 to step 1604. In step 1604 the base station generates System Information Block (SIB) information, e.g., System Information Block 1 (SIB 1) information, corresponding to one or more slots, said one or more slots including a Sub-Band Full Duplex (SBFD) slot including an uplink portion and a downlink portion, said SIB information including frequency information, e.g., a frequency offset parameter (e.g., msg1-FrequencyStart or msg1-FreqeuncyStartSBFD-r19 or ra-Msg1-RO-FrequencyOffsetSBFD-r19) indicating a start frequency of the uplink portion of said SBFD slot available for random access transmissions. In some embodiments, the information indicating a start frequency of the uplink portion of said SBFD slot available for random access transmissions is an offset which causes the frequency start location to fall within a range of frequencies available for uplink transmissions in an SBFD slot. Step 1604 includes one or more of steps 1606, 1608, 1610, 1612, 1614, 1616, 1618, and 1619.

In step 1606 the base station includes, in said SIB information, information, e.g., a msg1-FDM or a msg1-FDM-SBFD-r19, indicating a number (e.g., a number indicating the maximum number of PRACH ROs in PRACH duration and thus in some cases the maximum possible number of transmissions during a PRACH opportunity) of Physical Random Access Channel (PRACH) transmission occasions frequency division multiplexed (FMDed) into one PRACH duration.

In step 1608 the base station includes in said SIB information, a single frequency information parameter, e.g., a frequency offset parameter (e.g., a msg1-FrequecnyStart) indicating a start frequency of the uplink portion available for random access transmission, the single frequency information parameter indicating a start frequency which is applicable to both non-SBFD slots and SBFD slots, e.g., a start frequency which corresponds to the UL portion of the SBFD slot and which is also available for use in the non-SBFD slot for UL transmission.

In some embodiments, information indicating the number of Physical Random Access Channel (PRACH) transmission occasions FDMed in one PRACH duration is a number that limits the uplink PRBs to the uplink portion available in the SBFD slot even though the indicated number is used for both non-SBFD and SBFD slots (that is, a single set of frequency and occasion parameters is indicated with the information being applicable to non-SBFD and SBFD slots and the values selected so that the PRACH signaling is limited to the frequencies available in the SBFD slots for uplink signaling even though the parameters will be used for both type of slots and this will constrain the use of non-SBFD slots to a range for PRACH signaling which also works in the SBFD slots).

In step 1610 the base station generates separate information for a non-SBFD slot and a SBFD slot, the information fora non-SBFD slot including frequency start information, e.g., a frequency offset parameter (e.g., a msg1-FrequencyStart), corresponding to the non-SBFD slot and the information for a SBFD slot including frequency start information, e.g., a ra-Msg1-RO-FreqeuncyOffsetSBFD-r19, indicating the start frequency of the uplink portion of said SBFD slot available for random access transmissions.

In some embodiments, the frequency start information for the non-SBFD slot indicates a different start frequency than the frequency start information for the SBFD slot. In some such embodiments, the frequency start information for the non-SBFD slot indicates a frequency offset corresponding to a frequency outside the range of frequencies available in the SBFD slot for uplink signaling and the frequency start information for the SBFD slot indicates a frequency offset corresponding to a frequency in the range of frequencies available in the SBFD slot for uplink signaling.

In step 1612, the base station includes in said SIB information a scaling factor, e.g., a ra-RO-ScalaingFactorSBFD-r19, to be used by a UE when determining a start frequency offset to be used in an SBFD slot from the start frequency offset parameter included in the SIB information to indicate the start frequency offset to be used for the non-SBFD slot. For example, in some embodiments, a UE will determine the start frequency of the uplink portion of the SBFD slot based on a multiplication of the indicated start frequency offset, e.g., msg1-Freqeuncy Start*ra-RO-ScalingFactorSBFD-r19.

In step 1614 the base station includes in said SIB information a scaling factor, e.g., a ra-RO-ScalingFactorSBFD-r19, relating to the frequency information indicating a start frequency of the uplink portion of said SBFD slot available for random access transmissions. In some embodiments, the scaling information is to be used by a SBFD aware UE to determine the frequency offset of the lowest (e.g., in frequency) Random Access Channel (RACH) Occasion (abbreviated RO) in the SBFD slot based on frequency offset information corresponding to a non-SBFD slot. In some such embodiments, the scaling factor=UL usable PRB/UL BWP size where the UL BWP is the Bandwidth Part Size of the uplink portion of SBFD which can be used for RACH transmissions.

In step 1616 the base station generates SIB information for an uplink (UL) slot, said SIB information for the uplink slot including frequency information, e.g., a frequency offset parameter (e.g., a msg1-Freqeuncy Start) indicating a start frequency for a random access transmission opportunity that starts at a location in the UL slot, which is used for downlink transmission in said SBFD slot. For example, the start location indicated by the start frequency offset can correspond to a larger range of locations in the UL only slot, since all resources are available for UL transmissions in the UL only slot than in the SBFD slot, where only a small subset of resources are available for UL transmissions, and in some cases, will correspond to a frequency which is not available for UL transmission in the SBFD slot.

In step 1618 the base station includes in said SIB information, information, e.g., value communicated by a msg1-FDM parameter, indicating a number of PRACH transmission occasions FDMed in one time instance of the non-SBFD slot, said number being greater than the number permitted in a SBFD slot. In some embodiments, the value, e.g., communicated by msg1-FDM, indicates the maximum number of access attempt transmissions that are permitted using the non-SBFD slot.

In step 1619 the base station generates and communicates, in the SIB information, information, e.g., a value, e.g., communicated by the parameter msg1-FDM-SBFD-r19 or the parameter msg1-FDM, indicating a number of PRACH transmission occasions FDMed in one time instance of the SBFD slot.

Operation proceeds from step 1604 to step 1620. In step 1620 the base station transmits the generated SIB information from the base station, e.g., to one or more UEs, e.g., via broadcast signals. Step 1620 is performed repetitively, e.g., on an ongoing basis. Operation proceeds from step 1620 to step 1622. Step 1622 is performed repetitively on an ongoing basis.

In step 1622 the base station is operated to receive PRACH signals being communicated on RACH Occasions (ROs), e.g., PRACH Occasions, corresponding to SBFD slots and non-SBFD slots.

FIG. 17 is a flowchart 1700 of an exemplary method of operating a UE, e.g., a SBFD-aware UE, in accordance with an exemplary embodiment. The UE implementing the flowchart 1700 of FIG. 17, is, e.g., any of the SBFD-aware UEs (UE1A 1006, . . . . UENA 1008, UE1C 1014, . . . , UENC 1016) of system 1000 of FIG. 12, UE 1200, e.g., a SBFD-aware UE, of FIG. 13, or a UE, implemented in accordance with features of the present invention, supporting random access transmissions in both SBFD slots.

Operation of the exemplary method starts in step 1702, in which the UE is powered on and initialized. Operation proceeds from start step 1702 to step 1704. In step 1704 the UE receives SIB information, e.g., SIB1 information, corresponding to one or more slots, said one or more slots including a Sub-Band Full Duplex (SBFD) slot including an uplink portion and a downlink portion, said SIB information including frequency information (e.g., a frequency offset parameter (msg1-FrequencyStart or ra-Msg1-RO-FreqeuncyOffsetSBFD-r19) indicating a start frequency of the uplink portion of said SBFD slot available for random access transmissions. Step 1704 includes one or more of steps 1706, 1707, 1708, 1709, 1710 and 1712.

In step 1706 the UE receives information, e.g. a msg1-FDM, indicating a number of Physical Random Access Channel (PRACH) transmission occasions frequency division multiplexed (FMDed) in one PRACH duration. For example, the number indicates the maximum possible number of PRACh ROs in a PRACH duration and thus in some cases the maximum possible number of transmission during a PRACH transmission opportunity. In some embodiments, the number of Physical Random Access Channel (PRACH) transmission occasions FDMed in one PRACH duration is a number that limits the uplink Physical Resource Blocks (PRBs) to the uplink portion available in the SBFD slot even though the indicated number is used for both non-SBFD and SBFD slots (that is, a single set of frequency and occasion parameters is indicated with the information being applicable to non-SBFD and SBFD slots and the values selected so that the PRACH signaling is limited to the frequencies available in the SBFD slots for uplink signaling even though the parameters will be used for both type of slots and this will constrain the use of non-SBFD slots to a range for PRACH signaling which also works in the SBFD slots).

In step 1707 the UE receives information, e.g. a msg1-FDM, indicating a number of Physical Random Access Channel (PRACH) transmission occasions frequency division multiplexed (FMDed) in one PRACH duration for a non-SBFD slot.

In step 1709 the UE receives information, e.g. a msg1-FDM-SBFD-r19 or a msg1-FDM, indicating a number of Physical Random Access Channel (PRACH) transmission occasions frequency division multiplexed (FMDed) in one PRACH duration for a SBFD slot.

In step 1708 the UE receives a single frequency information parameter, e.g., a frequency offset parameter, e.g., a msg1-FreqeuncyStart, indicating a start frequency of the uplink portion available for random access transmission, the single frequency information parameter indicating a start frequency of the uplink portion available for random access transmission, the single frequency information parameter indicating a start frequency which is applicable to both said SBFD slots and said SBFD slots, e.g., a start frequency which corresponds to the UL portion of the SBFD slot and which is also available for used in non-SBFD slot for UL transmission.

In step 1710 the UE receives separate information for a non-SBFD slot and a SBFD slot, the information for a non-SBFD slot including frequency start information, e.g., a frequency offset parameter, e.g., a frequency offset parameter (e.g., a msg1-FrequencyStart) corresponding to the non-SBFD slot, and the information for a SBFD slot including frequency start information, e.g. a ra-Msg1-RO-FreqeuncyOffsetSBFD-r19, indicating the start frequency of the uplink portion of said SBFD slot available for random access transmissions.

In some embodiments, the frequency start information for the non-SBFD slot indicates a different start frequency than the frequency start information for the SBFD slot. In some such embodiments, the frequency start information for the non-SBFD slot indicates a frequency offset corresponding to a frequency outside the range of frequencies available in the SBFD slot for uplink signaling and the frequency start information for the SBFD slot indicates a frequency offset corresponding to a frequency in the range of frequencies available in the SBFD slot for uplink signaling.

In step 1712 the UE receives in said SIB information a scaling factor, e.g., a ra-RO-ScalingFactorSBFD-r19, to be used by a UE when determining a start frequency offset to be used in an SBFD slot from the start frequency offset parameter included in the SIB information to indicate the start frequency to be used for the non-SBFD slot.

Operation proceeds from step 1704 to 1714, in which the UE determines, a RACH Occasion (RO), e.g., a PRACH Occasion, for transmitting a PRACH signal, in a SBFD slot. In some embodiments, e.g., an embodiment including step 1712, step 1714 includes step 1716. In step 1716, the UE determines the start frequency offset for a SBFD slot based on a multiplication of the indicated start frequency offset for a non-SBFD slot and the scaling factor, e.g., msg1-FreqeuncyStart*ra-Ro-ScalingFactorSBFD-r19. Operation proceeds from step 1714 to step 1718, in which the UE transmits a RACH signal, e.g. a PRACH signal, in the determined RACH Occasion, e.g., a PRACH Occasion, in the SBFD slot.

In various embodiments, when user equipment (UE) wants to access the network, it will initiate an initial random access using the physical random access channel (PRACH) configuration provided by the network (NW) or gNodeB (gNB). This configuration helps the UE to identify the PRACH frequency/time domain resources to be used for sending an access request (Msg1) to the base station, e.g., gNB. The configured PRACH resources (time/frequency domain locations) for subband full duplex (SBFD) aware UEs are different from that of legacy UEs mainly because the SBFD random access channel (RACH) occasions (ROs) may fall in different regions of the resource block than that of the non-SBFD UEs. Consequently, SBFD-aware UEs will not use the legacy RACH resource configuration and will use new RACH configuration setup and signaling techniques. The new RACH configuration for SBFD-aware UEs will point to frequency/time resource locations within the SBFD UL symbols which can be used for sending Msg1 (initial access request) to the gNB. Resources for non-SBFD aware devices can also be used by SBFD-aware UEs. PRACH resource configuration, radio resource control (RRC) signaling information elements (IE) specify how the SBFD RACH configuration will be sent to SBFD UEs without conflicting with the legacy UEs' configuration.

Two different approaches for SBFD RACH configuration are contemplated and disclosed herein. In the first approach, existing legacy RRC IEs (msg1-FrequencyStart and msg1-FDM) are re-used to signal RACH configuration to SBFD UEs. In the second approach, RRC signaling IEs are introduced specifically for SBFD RACH configuration for SBFD-aware UEs. This second approach helps prevent invalid ROs when the legacy RRC IEs are used for both SBFD and non-SBFD (legacy) UEs. Regardless of the approach used, the RACH configuration is conveyed to the SBFD UEs via the system information block 1 (SIB1), which is transmitted by the gNB over the DL physical channel PDSCH with the UE reading the RACH configuration upon decoding SIB1.

Methods to signal different configuration options agreed by 3GPP RAN1. This application describes methods on how a gNB or NW can send this configuration to the SBFD-aware UE in such a way that the ROs stay within the usable UL physical resource blocks (PRBs) in the SBFD symbol of the initial BWP (Band Width Part) used for PRACH. In one approach the existing IEs (msg1-FrequencyStart and msg1-FDM) is used to signal the frequency offset and the number of ROs FDMed in time. The other approach is to introduce new RRC IEs for signaling which indicates the RACH configuration for RACH resources in SBFD UL symbols, specifically for SBFD-aware UEs.

In the first approach described herein, the signaling method/description facilitates harmonious use of the existing IEs without causing issues for the SBFD-aware UEs. Since the same IEs will be used for both legacy/non-SBFD and SBFD UEs, SBFD UEs may experience invalid ROs if the offset indicated by msg1-FrequencyStart results in ROs exceeding the boundary of SBFD UL symbol and usable PRBs (that is, ROs that spill into the SBFD DL symbol or unusable PRBs for PRACH). Our solution here specifies the UE behavior and gNB consideration when broadcasting SBFD RACH configuration using the same IE for both legacy and SBFD UEs. In such a case the gNB determines and ensures that the frequency offset of the lowest RO indicated by msg1-FrequencyStart remains within the SBFD UL usable PRB and the number of FDMed ROs indicated by msg1-FDM will be limited so that the configured ROs are within the UL usable PRBs.

For the second approach that uses at least some new IEs specifically for signaling SBFD RACH configuration for SBFD UEs, a new IEs (msg1-FrequencyStartSBFD-r19, msg1-FDM-SBFD-r19, ra-Msg1-RO-FrequencyOffsetSBFD-r19, and ra-RO-ScalingFactorSBFD-r19) for configuring SBFD specific RACH configuration based on the existing msg1-Frequency Start are used. This approach prevent indication of invalid ROs and ensures that configured ROs fro SBFD capable UEs are within the SBFD UL symbol while the legacy UEs continue to use msg1-FrequencyStart without conflict. This solution is suitable because configuring ra-Msg1-RO-FrequencyOffsetSBFD-r19 and ra-RO-ScalingFactorSBFD-r19 ensures gNB's a priori knowledge of the UL usable PRBs and the size of the UL BWP. In the present application we discuss how these new IEs can be encapsulated in the existing SIB1 signaling IE and provide descriptions/usage of these IEs in a Radio Resource Control (RRC) specification.

### First Numbered List of Exemplary Method Embodiments:

1. A method of operating a base station, the method comprising: generating (1604) System Information Block (SIB) information (e.g., SIB 1 information) corresponding to one or more slots, said one or more slots including a Sub-Band Full Duplex (SBFD) slot including an uplink portion and a downlink portion, said SIB information including frequency information (e.g., a frequency offset parameter (msg1-FrequencyStart or ra-Msg1-RO-FrequencyOffsetSBFD-r19) indicating a start frequency of the uplink portion of said SBFD slot available for random access transmissions; and transmitting (1620) the SIB information from the base station.

Method Embodiment 2. The method of Method Embodiment 1, wherein generating (1604) SIB information includes: including (1606) in said SIB information, information (e.g. msg1-FDM) indicating a number (e.g., a number indicating the maximum number of PRACH ROs in a PRACH duration and thus in some cases the max possible number of transmissions during a PRACH transmission opportunity) of Physical Random Access Channel (PRACH) transmission occasions (Frequency Division Multiplexed) FDMed in one PRACH duration.

Method Embodiment 2A. The method of Method Embodiment 2, wherein the SIB information (e.g., SIB 1 information) corresponding to one or more slots, includes (1608) a single frequency information parameter (e.g., a frequency offset parameter (msg1-FrequencyStart) indicating a start frequency of the uplink portion available for random access transmission, the single frequence information parameter indicating a start frequency which is applicable to both said non SBFD slots said SBFD slots (e.g., a start frequency which corresponds to the UL portion of the SBFD slot and which is also available for use in the non-SBFD slot for UL transmission).

Method Embodiment 2B. The method of Method Embodiment 2A, wherein the information indicating the number of Physical Random Access Channel (PRACH) transmission occasions FDMed in one PRACH duration is a number that limits the uplink PRBs to the uplink portion available in the SBFD slot even though the indicated number is used for both non-SBFD and SBFD slots (that is, a single set of frequency and occasion parameters is indicated with the information being applicable to non-SBFD and SBFD slots and the values selected so that the PRACH signaling is limited to the frequencies available in the SBFD slots for uplink signaling even though the parameters will be used for both type of slots and this will constrain the use of non-SBFD slots to a range for PRACH signaling which also works in the SBFD slots).

Method Embodiment 2C. The method of Method Embodiment 1, wherein generating (1604) SIB information (e.g., SIB 1 information) corresponding to one or more slots includes generating (1610) separate information for a non-SBFD and an SBFD slot, the information of a non-SBFD slot including frequency information (e.g., a frequency offset parameter (msg1-FrequencyStart) corresponding to the non-SBFD slot and said frequency start information (e.g., ra-Msg1-RO-FrequencyOffsetSBFD-r19) indicating the start frequency of the uplink portion of said SBFD slot available for random access transmissions.

Method Embodiment 2D. The method of Method Embodiment 2C wherein the frequency start information for the non-SBFD slot indicates a different start frequency than the frequency start information for the SBFD slot.

Method Embodiment 2E. The method of Method Embodiment 2D, wherein the frequency start information for the non-SBFD slot indicates a frequency offset corresponding to a frequency outside the range of frequencies available in the SBFD slot for uplink signaling and the frequency start information for the SBFD slot indicates a frequency offset corresponding to a frequency in the range of frequencies available in the SBFD slot for uplink signaling.

Method Embodiment 2F. The method of Method Embodiment 1, wherein generating (1604) SIB information further includes: including (1612) in the SIB information a scaling factor (e.g., ra-RO-ScalingFactorSBFD-r19) to be used by a UE when determining a start frequency offset to be used in an SBFD slot from the start frequency offset parameter included in the SIB information to indicate the start frequency offset to be used for the non-SBFD slot. (e.g., the UE will determine the start frequency offset for a SBFD slot based on a multiplication of the indicated start frequency offset (msg1-Frequency Start*ra-RO-ScalingFactorSBFD-r19)

Method Embodiment 3. The method of Method Embodiment 1, wherein said information indicating a start frequency of the uplink portion of said SBFD slot available for random access transmissions is an offset which causes the frequency start location to fall within a range of frequencies available for uplink transmissions in an SBFD slot.

Method Embodiment 4. The method of Method Embodiment 1, wherein generating (1604) SIB information further includes: including (1614) in said SIB information a scaling factor (e.g., ra-RO-ScalingFactorSBFD-R19) relating to the frequency information indicating a start frequency of the uplink portion of said SBFD slot available for random access transmissions.

Method Embodiment 5. The method of Method Embodiment 4, wherein said scaling information is to be used by a SBFD aware UE to determine the frequency offset of the lowest (e.g., in frequency) Random Access Channel (RACH) Occasion (abbreviated RO) in the SBFD slot based on frequency offset information corresponding to a non-SBFD slot.

Method Embodiment 6. The method of Method Embodiment 5, wherein the scaling factor=UL usable PRB/UL BWP size where the UL BWP is the Bandwidth Part Size of the uplink portion of SBFD which can be used for RACH transmissions.

Method Embodiment 7. The method of Method Embodiment 2, wherein generating (1604) SIB information corresponding to one or more slots, further includes: generating (1616) SIB information for an UL slot (e.g., a legacy UL slot which can be used for uplink only transmissions), said SIB information for the UL slot including frequency information (e.g., a frequency offset parameter (msg1-FrequencyStart)) indicating a start frequency for a random access transmission opportunity that starts at a location in the UL slot which is used for downlink transmissions in said SBFD slot (e.g., the start location indicated by the start frequency offset can correspond to a larger range of locations in the UL only slot since all resources are available for UL transmissions than in the SBFD slot where only a small subset of resources are available for UL transmissions and in some cases will correspond to a frequency which is not available for UL transmission in the SBFD slot).

Method Embodiment 8. The method of Method Embodiment 7, wherein generating (1604) SIB information corresponding to one or more slots, further includes: including (1618) in said SIB information, information indicating a number of Physical Random Access Channel (PRACH) transmissions occasions FDMed in one time instance of the non-SBFD slot (e.g., a value (msg1-FDM) indicating the maximum number of access attempt transmissions that are permitted using the non-SBFD UL slot, said maximum number being a number greater than the number which is used to limit PRACH transmissions during an access attempt using the SBFD slot), said number being greater than the number permitted in a SBFD slot.

### First Numbered List of Exemplary Apparatus Embodiments:

Apparatus Embodiment 1. A base station (1002, 1004 or 1100) comprising: a receiver (1118), a transmitter (1120); and a processor (1102) configured to control the base station to: generate (1604) System Information Block (SIB) information (e.g., SIB 1 information) corresponding to one or more slots, said slots including a Sub-band full duplex (SBFD) slot including an uplink portion and a downlink portion, said SIB information including frequency information (e.g., a frequency offset parameter (msg1-FrequencyStart or ra-Msg1-RO-FrequencyOffsetSBFD-r19)) indicating a start frequency of the uplink portion of said SBFD slot available for random access transmissions; and transmit (1620) (via transmitter (1120)) the SIB information from the base station.

Apparatus Embodiment 2. The base station of Apparatus Embodiment 1, wherein said processor (1102) is further configured to: include (1606) in said SIB information, information (e.g. msg1-FDM) indicating a number (e.g., a number indicating the maximum number of PRACH ROs in a PRACH duration and thus in some cases the max possible number of transmissions during a PRACH transmission opportunity) of Physical Random Access Channel (PRACH) transmission occasions (Frequency Division Multiplexed) FDMed in one PRACH duration, as part of being configured to control the base station to generate (1604) SIB information.

Apparatus Embodiment 2A. The base station of Apparatus Embodiment 2, wherein the SIB information (e.g., SIB 1 information) corresponding to one or more slots, includes (1608) a single frequency information parameter (e.g., a frequency offset parameter (msg1-FrequencyStart)) indicating a start frequency of the uplink portion available for random access transmission, the single frequence information parameter indicating a start frequency which is applicable to both said non SBFD slots said SBFD slots (e.g., a start frequency which corresponds to the UL portion of the SBFD slot and which is also available for use in the non-SBFD slot for UL transmission).

Apparatus Embodiment 2B. The base station of Apparatus Embodiment 2A, wherein the information indicating the number of Physical Random Access Channel (PRACH) transmission occasions FDMed in one PRACH duration is a number that limits the uplink PRBs to the uplink portion available in the SBFD slot even though the indicated number is used for both non-SBFD and SBFD slots (that is, a single set of frequency and occasion parameters is indicated with the information being applicable to non-SBFD and SBFD slots and the values selected so that the PRACH signaling is limited to the frequencies available in the SBFD slots for uplink signaling even though the parameters will be used for both type of slots and this will constrain the use of non-SBFD slots to a range for PRACH signaling which also works in the SBFD slots).

Apparatus Embodiment 2C. The base station, of Apparatus Embodiment 1, wherein said processor (1102) is further configured to: control the base station to generate (1610) separate information for a non-SBFD and an SBFD slot, the information for a non-SBFD slot including frequency start information (e.g., a frequency offset parameter (msg1-Frequency Start) corresponding to the non-SBFD slot and the information for a SBFD slot including frequency start information (e.g., ra-Msg1-RO-FrequencyOffsetSBFD-r19) indicating the start frequency of the uplink portion of said SBFD slot available for random access transmissions, as part of being configured to control the base station to generate (1604) SIB information (e.g., SIB 1 information) corresponding to one or more slots.

Apparatus Embodiment 2D. The base station of Apparatus Embodiment 2C wherein the frequency start information for the non-SBFD slot indicates a different start frequency than the frequency start information for the SBFD slot.

Apparatus Embodiment 2E. The base station of Apparatus Embodiment 2D, wherein the frequency start information for the non-SBFD slot indicates a frequency offset corresponding to a frequency outside the range of frequencies available in the SBFD slot for uplink.

Apparatus Embodiment 2F. The base station of Apparatus Embodiment 1, wherein said processor (1102) is configured to control the base station to: include (1612) in the SIB information a scaling factor (e.g., ra-RO-ScalingFactorSBFD-r19) to be used by a UE when determining a start frequency offset to be used in an SBFD slot from the start frequency offset parameter included in the SIB information to indicate the start frequency offset to be used for the non-SBFD slot. (e.g., the UE will determine the start frequency offset for a SBFD slot based on a multiplication of the indicated start frequency offset (msg1-Frequency Start*ra-RO-ScalingFactorSBFD-r19), as part of being configured to control the base station to generate (1604) SIB information.

Apparatus Embodiment 3. The base station of Apparatus Embodiment 1, wherein said information indicating a start frequency of the uplink portion of said SBFD slot available for random access transmissions is an offset which causes the frequency start location to fall within a range of frequencies available for uplink transmissions in an SBFD slot.

Apparatus Embodiment 4. The base station of Apparatus Embodiment 1, wherein said processor (1102) is configured to control the base station to:
include (1614) in said SIB information a scaling factor (e.g., ra-RO-ScalingFactorSBFD-R19) relating to the frequency information indicating a start frequency of the uplink portion of said SBFD slot available for random access transmissions, as part of being configured to control the base station to generate (1604) SIB information.

Apparatus Embodiment 5. The base station of Apparatus Embodiment 4, wherein said scaling information is to be used by a SBFD aware UE to determine the frequency offset of the lowest (e.g., in frequency) Random Access Channel (RACH) Occasion (abbreviated RO) in the SBFD slot based on frequency offset information corresponding to a non-SBFD slot.

Apparatus Embodiment 6. The base station of Apparatus Embodiment 5, wherein the scaling factor=UL usable PRB/UL BWP size where the UL BWP is the Bandwidth Part Size of the uplink portion of SBFD which can be used for RACH transmissions.

Apparatus Embodiment 7. The base station of Apparatus Embodiment 2, wherein said processor (1102) is configured to control the base station to: generate (1616) SIB information for an UL slot (e.g., a legacy UL slot which can be used for uplink only transmissions), said SIB information for the UL slot including frequency information (e.g., a frequency offset parameter (msg1-FrequencyStart) indicating a start frequency for a random access transmission opportunity that starts at a location in the UL slot which is used for downlink transmissions in said SBFD slot (e.g., the start location indicated by the start frequency offset can correspond to a larger range of locations in the UL only slot since all resources are available for UL transmissions than in the SBFD slot where only a small subset of resources are available for UL transmissions and in some cases will correspond to a frequency which is not available for UL transmission in the SBFD slot), as part of being configured to control the base station to generate (1604) SIB information corresponding to one or more slots.

Apparatus Embodiment 8. The base station of Apparatus Embodiment 7, wherein said processor (1102) is configured to control the base station to: include (1618) in said SIB information, information indicating a number of Physical Random Access Channel (PRACH) transmissions occasions FDMed in one time instance of the non-SBFD slot (e.g., a value (msg1-FDM) indicating the maximum number of access attempt transmissions that are permitted using the non-SBFD UL slot, said maximum number being a number greater than the number which is used to limit PRACH transmissions during an access attempt using the SBFD slot), said number being greater than the number permitted in a SBFD slot, as part of being configured to control the base station to generate (1604) SIB information corresponding to one or more slots.

### Second Numbered List of Exemplary Method Embodiments:

Method Embodiment 1. A method of operating a user equipment (UE), the method comprising: receiving (1704) System Information Block (SIB) information (e.g., SIB 1 information), corresponding to one or more slots, said one or more slots including a Sub-band full duplex (SBFD) slot including an uplink portion and a downlink portion, said SIB information including frequency information (e.g., a frequency offset parameter (msg1-Frequency Start or ra-Msg1-RO-FrequencyOffsetSBFD-r19)) indicating a start frequency of the uplink portion of said SBFD slot available for random access transmissions; and transmitting (1718) a Random Access Channel (RACH) signal (e.g., a PRACH signal) in the SBFD slot.

Method Embodiment 2. The method of Method Embodiment 1, wherein the received said SIB information includes (1706) information (e.g. msg1-FDM) indicating a number (e.g., a number indicating the maximum number of PRACH ROs in a PRACH duration and thus in some cases the max possible number of transmissions during a PRACH transmission opportunity) of Physical Random Access Channel (PRACH) transmission occasions Frequency Division Multiplexed (FDMed) in one PRACH duration.

Method Embodiment 2A. The method of Method Embodiment 2, wherein the received SIB information (e.g., SIB 1 information) corresponding to one or more slots, includes (1708) a single frequency information parameter (e.g., a frequency offset parameter (msg1-FrequencyStart)) indicating a start frequency of the uplink portion available for random access transmission, the single frequence information parameter indicating a start frequency which is applicable to both said non-SBFD slots said SBFD slots (e.g., a start frequency which corresponds to the UL portion of the SBFD slot and which is also available for use in the non-SBFD slot for UL transmission).

Method Embodiment 2B. The method of Method Embodiment 2A, wherein the received SIB information indicating the number of Physical Random Access Channel (PRACH) transmission occasions FDMed in one PRACH duration is a number that limits the uplink Physical Resource Blocks (PRBs) to the uplink portion available in the SBFD slot even though the indicated number is used for both non-SBFD and SBFD slots (that is, a single set of frequency and occasion parameters is indicated with the information being applicable to non-SBFD and SBFD slots and the values selected so that the PRACH signaling is limited to the frequencies available in the SBFD slots for uplink signaling even though the parameters will be used for both type of slots and this will constrain the use of non-SBFD slots to a range for PRACH signaling which also works in the SBFD slots).

Method Embodiment 2C. The method of Method Embodiment 1, wherein SIB information (e.g., SIB 1 information) corresponding to one or more slots includes (1710) separate information for a non-SBFD and an SBFD slot, the information for a non-SBFD slot including frequency start information (e.g., a frequency offset parameter (msg1-Frequency Start) corresponding to the non-SBFD slot and the information for a SBFD slot including frequency start information (e.g., ra-Msg1-RO-FrequencyOffsetSBFD-r19) indicating the start frequency of the uplink portion of said SBFD slot available for random access transmissions.

Method Embodiment 2D. The method of Method Embodiment 2C wherein the frequency start information for the non-SBFD slot indicates a different start frequency than the frequency start information for the SBFD slot.

Method Embodiment 2E. The method of Method Embodiment 2D, wherein the frequency start information for the non-SBFD slot indicates a frequency offset corresponding to a frequency outside the range of frequencies available in the SBFD slot for uplink signaling and the frequency start information for the SBFD slot indicates a frequency offset corresponding to a frequency in the range of frequencies available in the SBFD slot for uplink signaling.

Method Embodiment 2F. The method of Method Embodiment 1, wherein the SIB information further includes (1712) a scaling factor (e.g., ra-RO-ScalingFactorSBFD-r19) to be used by a UE when determining a start frequency offset to be used in an SBFD slot from the start frequency offset parameter included in the SIB information to indicate the start frequency offset to be used for the non-SBFD slot.

Method Embodiment 2G. The method of Method Embodiment 2F, further comprising: operating (1716) the UE to determine the start frequency offset for a SBFD slot based on a multiplication of the indicated start frequency offset for a non-SBFD slot and the scaling factor (e.g., msg1-FrequencyStart*ra-RO-ScalingFactorSBFD-r19).

### Second Numbered List of Exemplary Apparatus Embodiments:

Apparatus Embodiment 1. A user equipment (UE) (1006, 1008, 1014, 1006, or 1200) comprising: a wireless receiver (1224); a wireless transmitter (1226); and a processor (1202) configured to control the UE to: receive (1704), via wireless receiver (1224), System Information Block (SIB) information (e.g., SIB 1 information), corresponding to one or more slots, said one or more slots including a Sub-band full duplex (SBFD) slot including an uplink portion and a downlink portion, said SIB information including frequency information (e.g., a frequency offset parameter (msg1-FrequencyStart or ra-Msg1-RO-FrequencyOffsetSBFD-r19) indicating a start frequency of the uplink portion of said SBFD slot available for random access transmissions; and transmit (1718), via wireless transmitter (1226), a Random Access Channel (RACH) signal (e.g., a PRACH signal) in the SBFD slot.

Apparatus Embodiment 2. The UE of Apparatus Embodiment 1, wherein the received said SIB information includes (1706) information (e.g. msg1-FDM) indicating a number (e.g., a number indicating the maximum number of PRACH ROs in a PRACH duration and thus in some cases the max possible number of transmissions during a PRACH transmission opportunity) of Physical Random Access Channel (PRACH) transmission occasions Frequency Division Multiplexed (FDMed) in one PRACH duration.

Apparatus Embodiment 2A. The UE of Apparatus Embodiment 2, wherein the received SIB information (e.g., SIB 1 information) corresponding to one or more slots, includes (1708) a single frequency information parameter (e.g., a frequency offset parameter (msg1-FrequencyStart) indicating a start frequency of the uplink portion available for random access transmission, the single frequence information parameter indicating a start frequency which is applicable to both said non-SBFD slots said SBFD slots (e.g., a start frequency which corresponds to the UL portion of the SBFD slot and which is also available for use in the non-SBFD slot for UL transmission).

Apparatus Embodiment 2B. The UE of Apparatus Embodiment 2A, wherein the received SIB information indicating the number of Physical Random Access Channel (PRACH) transmission occasions FDMed in one PRACH duration is a number that limits the uplink Physical Resource Blocks (PRBs) to the uplink portion available in the SBFD slot even though the indicated number is used for both non-SBFD and SBFD slots (that is, a single set of frequency and occasion parameters is indicated with the information being applicable to non-SBFD and SBFD slots and the values selected so that the PRACH signaling is limited to the frequencies available in the SBFD slots for uplink signaling even though the parameters will be used for both type of slots and this will constrain the use of non-SBFD slots to a range for PRACH signaling which also works in the SBFD slots).

Apparatus Embodiment 2C. The UE of Apparatus Embodiment 1, wherein SIB information (e.g., SIB 1 information) corresponding to one or more slots includes (1710) separate information for a non-SBFD and an SBFD slot, the information for a non-SBFD slot including frequency start information (e.g., a frequency offset parameter (msg1-Frequency Start) corresponding to the non-SBFD slot and the information for a SBFD slot including frequency start information (e.g., ra-Msg1-RO-FrequencyOffsetSBFD-r19) indicating the start frequency of the uplink portion of said SBFD slot available for random access transmissions.

Apparatus Embodiment 2D. The UE of Apparatus Embodiment 2C wherein the frequency start information for the non-SBFD slot indicates a different start frequency than the frequency start information for the SBFD slot.

Apparatus Embodiment 2E. The UE of Apparatus Embodiment 2D, wherein the frequency start information for the non-SBFD slot indicates a frequency offset corresponding to a frequency outside the range of frequencies available in the SBFD slot for uplink signaling and the frequency start information for the SBFD slot indicates a frequency offset corresponding to a frequency in the range of frequencies available in the SBFD slot for uplink signaling.

Apparatus Embodiment 2F. The UE of Apparatus Embodiment 1, wherein the SIB information further includes (1712) a scaling factor (e.g., ra-RO-ScalingFactorSBFD-r19) to be used by a UE when determining a start frequency offset to be used in an SBFD slot from the start frequency offset parameter included in the SIB information to indicate the start frequency offset to be used for the non-SBFD slot.

Apparatus Embodiment 2G. The UE of Apparatus Embodiment 2F, wherein said processor (1202) is further configured to: operating (1716) the UE to determine the start frequency offset for a SBFD slot based on a multiplication of the indicated start frequency offset for a non-SBFD slot and the scaling factor (e.g., msg1-FrequencyStart*ra-RO-ScalingFactorSBFD-r19).

The techniques of various embodiments may be implemented using software, hardware and/or a combination of software and hardware. Various embodiments are directed to apparatus, e.g., base stations, user equipment (UE) devices, core network devices (e.g., PCF devices, AMF devices, SMF devices, UPF devices, UDM devices, UDR devices, AUSF devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating base stations, user equipment (UE) devices, core network devices (e.g., PCF devices, AMF devices, SMF devices, UPF devices, AUSF devices, UDM devices, UDR devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., base stations, user equipment (UE) devices, core network devices (e.g., PCF devices, AMF devices, SMF devices, UPF devices, UDM devices, UDR devices, AUSF devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning and/or configuring user equipment devices, provisioning and/or configuring AP devices, provisioning AAA servers, provisioning orchestration servers, generating messages, message reception, message transmission, signal processing, sending, comparing, determining and/or transmission steps. Thus, in some embodiments various features are implemented using components, or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., base stations, user (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the base stations, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., a base station, a user equipment (UE) device, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a base station, the method comprising:
generating System Information Block (SIB) information corresponding to one or more slots, said one or more slots including a Sub-Band Full Duplex (SBFD) slot including an uplink portion and a downlink portion, said SIB information including frequency information indicating a start frequency of the uplink portion of said SBFD slot available for random access transmissions; and
transmitting the SIB information from the base station.

2. The method of claim 1, wherein generating SIB information includes:
including in said SIB information, information indicating a number of Physical Random Access Channel (PRACH) transmission occasions (Frequency Division Multiplexed) FDMed in one PRACH duration.

3. The method of claim 1, wherein said information indicating a start frequency of the uplink portion of said SBFD slot available for random access transmissions is an offset which causes the frequency start location to fall within a range of frequencies available for uplink transmissions in an SBFD slot.

4. The method of claim 1, wherein generating SIB information further includes:
including in said SIB information a scaling factor relating to the frequency information indicating a start frequency of the uplink portion of said SBFD slot available for random access transmissions.

5. The method of claim 4, wherein said scaling information is to be used by a SBFD aware UE to determine the frequency offset of the lowest Random Access Channel (RACH) Occasion (RO) in the SBFD slot based on frequency offset information corresponding to a non-SBFD slot.

6. The method of claim 5, wherein the scaling factor=UL usable PRB/UL BWP size where the UL BWP is the Bandwidth Part Size of the uplink portion of SBFD which can be used for RACH transmissions.

7. The method of claim 2, wherein generating SIB information corresponding to one or more slots, further includes:
generating SIB information for an UL slot, said SIB information for the UL slot including frequency information (e.g., a frequency offset parameter (msg1-FrequencyStart) indicating a start frequency for a random access transmission opportunity that starts at a location in the UL slot which is used for downlink transmissions in said SBFD slot.

8. The method of claim 7, wherein generating SIB information corresponding to one or more slots, further includes:
including in said SIB information, information indicating a number of Physical Random Access Channel (PRACH) transmissions occasions FDMed in one time instance of the non-SBFD slot, said number being greater than the number permitted in a SBFD slot.

9. A base station comprising:
a receiver;
a transmitter; and
a processor configured to control the base station to:
generate System Information Block (SIB) information corresponding to one or more slots, said slots including a Sub-band full duplex (SBFD) slot including an uplink portion and a downlink portion, said SIB information including frequency information indicating a start frequency of the uplink portion of said SBFD slot available for random access transmissions; and
transmit the SIB information from the base station.

10. The base station of claim 9, wherein said processor is further configured to:
include in said SIB information, information indicating a number of Physical Random Access Channel (PRACH) transmission occasions (Frequency Division Multiplexed) FDMed in one PRACH duration, as part of being configured to control the base station to generate SIB information.

11. The base station of claim 10, wherein the SIB information corresponding to one or more slots, includes a single frequency information parameter indicating a start frequency of the uplink portion available for random access transmission, the single frequence information parameter indicating a start frequency which is applicable to both said non SBFD slots said SBFD slots.

12. The base station of claim 11, wherein the information indicating the number of Physical Random Access Channel (PRACH) transmission occasions FDMed in one PRACH duration is a number that limits the uplink PRBs to the uplink portion available in the SBFD slot even though the indicated number is used for both non-SBFD and SBFD slots.

13. The base station, of claim 9, wherein said processor is further configured to:
control the base station to generate separate information for a non-SBFD and a SBFD slot, the information fora non-SBFD slot including frequency start information corresponding to the non-SBFD slot and said information for a SBFD slot including frequency start information indicating the start frequency of the uplink portion of said SBFD slot available for random access transmissions, as part of being configured to control the base station to generate SIB information corresponding to one or more slots.

14. The base station of claim 13, wherein the frequency start information for the non-SBFD slot indicates a different start frequency than the frequency start information for the SBFD slot.

15. The base station of claim 14, wherein the frequency start information for the non-SBFD slot indicates a frequency offset corresponding to a frequency outside the range of frequencies available in the SBFD slot for uplink.

16. A method of operating a user equipment (UE), the method comprising:
receiving System Information Block (SIB) information, corresponding to one or more slots, said one or more slots including a Sub-band full duplex (SBFD) slot including an uplink portion and a downlink portion, said SIB information including frequency information indicating a start frequency of the uplink portion of said SBFD slot available for random access transmissions; and
transmitting a Random Access Channel (RACH) signal in the SBFD slot.

17. The method of claim 16, wherein the received said SIB information includes information indicating a number of Physical Random Access Channel (PRACH) transmission occasions Frequency Division Multiplexed (FDMed) in one PRACH duration.

18. The method of claim 17, wherein the received SIB information corresponding to one or more slots, includes a single frequency information parameter indicating a start frequency of the uplink portion available for random access transmission, the single frequence information parameter indicating a start frequency which is applicable to both said non-SBFD slots said SBFD slots.

19. The method of claim 18,
wherein the received SIB information indicating the number of Physical Random Access Channel (PRACH) transmission occasions FDMed in one PRACH duration is a number that limits the uplink Physical Resource Blocks (PRBs) to the uplink portion available in the SBFD slot even though the indicated number is used for both non-SBFD and SBFD slots.

20. The method of claim 16, wherein SIB information corresponding to one or more slots includes separate information for a non-SBFD and an SBFD slot, the information for a non-SBFD slot including frequency start information corresponding to the non-SBFD slot and the information for a SBFD slot including frequency start information indicating the start frequency of the uplink portion of said SBFD slot available for random access transmissions.

21. The method of claim 20, wherein the frequency start information for the non-SBFD slot indicates a different start frequency than the frequency start information for the SBFD slot.

22. The method of claim 21, wherein the frequency start information for the non-SBFD slot indicates a frequency offset corresponding to a frequency outside the range of frequencies available in the SBFD slot for uplink signaling and the frequency start information for the SBFD slot indicates a frequency offset corresponding to a frequency in the range of frequencies available in the SBFD slot for uplink signaling.

23. The method of claim 16, wherein the SIB information further includes a scaling factor to be used by a UE when determining a start frequency offset to be used in an SBFD slot from the start frequency offset parameter included in the SIB information to indicate the start frequency offset to be used for the non-SBFD slot.

24. The method of claim 23, further comprising:
operating the UE to determine the start frequency offset for a SBFD slot based on a multiplication of the indicated start frequency offset for a non-SBFD slot and the scaling factor.

25. A user equipment (UE) comprising:
a wireless receiver;
a wireless transmitter; and
a processor configured to control the UE to:
receive, via wireless receiver, System Information Block (SIB) information, corresponding to one or more slots, said one or more slots including a Sub-band full duplex (SBFD) slot including an uplink portion and a downlink portion, said SIB information including frequency information indicating a start frequency of the uplink portion of said SBFD slot available for random access transmissions; and
transmit, via wireless transmitter, a Random Access Channel (RACH) signal in the SBFD slot.

26. The UE of claim 25, wherein the received said SIB information includes information indicating a number of Physical Random Access Channel (PRACH) transmission occasions Frequency Division Multiplexed (FDMed) in one PRACH duration.

27. The UE of claim 26, wherein the received SIB information corresponding to one or more slots, includes a single frequency information parameter indicating a start frequency of the uplink portion available for random access transmission, the single frequence information parameter indicating a start frequency which is applicable to both said non-SBFD slots said SBFD slots.

28. The UE of claim 27, wherein the received SIB information indicating the number of Physical Random Access Channel (PRACH) transmission occasions FDMed in one PRACH duration is a number that limits the uplink Physical Resource Blocks (PRBs) to the uplink portion available in the SBFD slot even though the indicated number is used for both non-SBFD and SBFD slots.

29. The UE of claim 25, wherein SIB information corresponding to one or more slots includes separate information for a non-SBFD and an SBFD slot, the information for a non-SBFD slot including frequency start information corresponding to the non-SBFD slot and the information for a SBFD slot including frequency start information indicating the start frequency of the uplink portion of said SBFD slot available for random access transmissions.

30. The UE of claim 29, wherein the frequency start information for the non-SBFD slot indicates a different start frequency than the frequency start information for the SBFD slot.
